(19) United States
(12) Patent Application Publication
(10) Pub. No.: US 2020/0064973 A1
(43) Pub. Date: Feb. 27, 2020

(54) COMPOSITE MEMBER AND DEVICE

(71) Applicant: FUJIFILM Corporation, Tokyo (JP)

(72) Inventors: Tetsuro MITSUI, Kanagawa (JP); Hidetoshi HIRATA, Kanagawa (JP)

(73) Assignee: FUJIFILM Corporation, Tokyo (JP)

(21) Appl. No.: 16/670,355

(22) Filed: Oct. 31, 2019

Related U.S. Application Data
(63) Continuation of application No. PCT/JP2018/019734, filed on May 23, 2018.

(30) Foreign Application Priority Data
Jun. 26, 2017 (JP) 2017-123999

(51) Int. Cl. G06F 3/044; B32B 7/12; B32B 15/08; B32B 27/08

(52) U.S. Cl. CPC G06F 3/0446; B32B 7/12; B32B 15/08; B32B 27/08; G06F 2203/04102; B32B 2457/208; B32B 2307/202; B32B 2307/206; B32B 2307/51; B32B 2307/546; G06F 2203/04112

(57) ABSTRACT

A composite member has a pressure-sensitive adhesive layer, a conductive layer body including an insulating layer having a higher modulus of elasticity than the pressure-sensitive adhesive layer and two conductive layers electrically insulated by the insulating layer and disposed to be spaced from each other, and a member having a higher modulus of elasticity than the pressure-sensitive adhesive layer, in which the member is in contact with, out of the two conductive layers, a first conductive layer provided on a side on which a radius of curvature of the insulating layer is larger in a case of bending the conductive layer body in a bending direction, and the pressure-sensitive adhesive layer is disposed at a portion except for between the insulating layer and each of the two conductive layers and between the first conductive layer and the member having a higher modulus of elasticity than the pressure-sensitive adhesive layer.

### CROSS-REFERENCE TO RELATED APPLICATIONS

This application is a Continuation of PCT International Application No. PCT/JP2018/019734 filed on May 23, 2018, which claims priority under 35 U.S.C. § 119(a) to Japanese Patent Application No. 2017-123999 filed on Jun. 26, 2017. Each of the above application(s) is hereby expressly incorporated by reference, in its entirety, into the present application.

### BACKGROUND OF THE INVENTION

### 1. Field of the Invention

The present invention relates to a composite member having a conductive layer sandwiched by pressure-sensitive adhesive layers and a device having the composite member and particularly to a composite member that controls stress exerted on a conductive layer and a device having the composite member.

### 2. Description of the Related Art

In recent years, sheets having a conductive layer configured of a conductive wire have been used in a variety of uses such as electromagnetic wave shields of a variety of devices, antennas, a variety of sensors, heating elements, and electrodes. An electrode refers to, for example, an electrode in a variety of electronic devices such as a solar cell, an inorganic electroluminescence (EL) element, and an organic electroluminescence (EL) element.

Other than the above-described uses, the above-described sheets are being used in touch panels. In a variety of electronic devices including portable information devices such as a tablet-type computer and a smartphone, touch panels that are used in combination with a display device such as a liquid crystal display device and are used for an input operation carried out on an electronic device by being touched on a screen are becoming popular.

Furthermore, development of devices in an aspect in which a touch panel is folded or an aspect in which a touch panel is curled is underway. Such development enables electronic devices to be compacted and enables stylish designs, which can be used as an appeal point.

In order to fold a touch panel, individual members configuring the touch panel need to be so tolerant that the members are not broken or fractured by being folded and do not lose their performance. Regarding the above-described need, a folding characteristic is important particularly for a cover material, a touch panel, and a panel, and studies are underway regarding the respective members.

Generally, bending of a laminate exerts a compressive stress inside and a tensile stress outside, and an attempt is made to locate a weak member in a middle portion in which there is no stress. For example, in a flexible touch screen panel of US2014/0354558A, a wire layer of a flexible film is present on a neutral surface of the flexible film. The wire layer is further protected by a flexible supplementary film, and the generation of a defect by the cracking of the wire layer in the case of being bent is suppressed. The neutral surface is a region in which substantially no stress is exerted in the case of bending a flexible touch screen panel.

In addition, US2015/0268914A discloses a display having a neutral surface on a display element or a thin film sealing layer.

In addition to the above-described members, there are some cases where, in a laminate, a layer having an extremely low modulus of elasticity is inserted on purpose as a stress relaxation layer, a plurality of stress middle points is generated, and a weak base material is located on the stress middle points. As a weak base material site, for example, a wire portion such as a thin film transistor (TFT) in an organic electroluminescence (EL) display and a conductive layer such as an electrode wire for a touch panel are exemplified.

A flexible display device of US2015/0201487A has a flexible outside member disposed on a flexible display panel and an adhesive member disposed between the flexible display panel and the flexible outside member. The modulus of elasticity of the adhesive member is set so that neutral surfaces are respectively formed on the flexible display panel and the flexible outside member. The modulus of elasticity of the adhesive member is 1/10,000 to 1/1,000 of the moduli of elasticity of the flexible display panel and the flexible outside member.

US2015/0200375A describes a flexible display device having a flexible outside member disposed on a flexible display panel and a stress control member disposed between the flexible display panel and the flexible outside member. The stress control member is configured to demarcate a first neutral surface and a second neutral surface respectively on the flexible display panel and the flexible outside member in the case of folding the flexible display device.

### SUMMARY OF THE INVENTION

As described above, in a wire portion such as a thin film transistor (TFT) and an electrode wire for a touch panel, a wire or the like break in a case where a tensile stress is exerted thereon. In all of US2014/0354558A, US2015/0268914A, US2015/0201487A, and US2015/0200375A, folding resistance is exhibited by generating the middle point in which there is no stress. However, in US2014/0354558A. US2015/0268914A, US2015/0201487A, and US2015/0200375A, it is not possible to sufficiently decrease the tensile stress by adjusting the stress being exerted on the wire portion such as a thin film transistor (TFT) and the conductive layer such as an electrode wire for a touch panel, and it is not possible to obtain sufficient folding resistance.

An object of the present invention is to solve a problem based on the above-described related art and provide a composite member and a device capable of controlling stress being exerted on a conductive layer.

In order to attain the above-described object, the present invention provides a composite member comprising: a conductive layer body including an insulating layer and two conductive layers that are electrically insulated by the insulating layer and disposed to be spaced from each other; a pressure-sensitive adhesive layer; and a member having a higher modulus of elasticity than the pressure-sensitive adhesive layer, in which the member is in contact with, out of the two conductive layers, a first conductive layer provided on a side on which a radius of curvature of the insulating layer is larger in a case of bending the conductive layer body in a bending direction, the pressure-sensitive adhesive layer is disposed at a portion except for between the insulating layer and each of the two conductive layers and at a portion except for between the first conductive layer and the member having a higher modulus of elasticity than the pressure-sensitive adhesive layer, and the insulating layer has a higher modulus of elasticity than the pressure-sensitive adhesive layer.

The insulating layer is preferably flexible. In addition, the modulus of elasticity of the insulating layer is preferably 10⁻³ to 30 GPa.

The member having a higher modulus of elasticity is preferably formed of a sheet body and disposed on a side of the first conductive layer opposite to the insulating layer.

A first protective layer having a higher modulus of elasticity than the pressure-sensitive adhesive layer is preferably laminated on the first conductive layer.

The first protective layer is preferably in contact with the first pressure-sensitive adhesive layer provided on a side of the first protective layer opposite to the conductive layer.

In a case where a thickness from an interface between the first protective layer and the first conductive layer to an interface of the pressure-sensitive adhesive layer that is disposed first on a side on which the radius of curvature of the insulating layer is smaller in the case of bending the conductive layer body in the bending direction is represented by td, and a thickness of the first protective layer is represented by ts, ts is preferably equal to or smaller than td.

It is preferable that a second protective layer having a thickness of 20 μm or smaller is laminated on a second conductive layer provided on a side on which a radius of curvature of the insulating layer is smaller in the case of bending the conductive layer body in the bending direction and the second protective layer is in contact with a second pressure-sensitive adhesive layer provided on a side of the second protective layer opposite to the second conductive layer.

The second pressure-sensitive adhesive layer provided on the side on which the radius of curvature of the insulating layer is smaller in the case of bending the conductive layer body in the bending direction and the second conductive layer provided on the side on which the radius of curvature of the insulating layer is smaller in the case of bending the conductive layer body in the bending direction are preferably in contact with each other.

The conductive layer body preferably has the insulating layer and the conductive layers provided on both surfaces of the insulating layer. In this case, the insulating layer is preferably formed of an insulating substrate.

In addition, the two conductive layers are preferably formed of metal.

A barrier layer may be provided between the insulating layer and one of the two conductive layers or on the side of the two conductive layers opposite to the insulating layer, and the barrier layer may have an inorganic layer including at least silicon nitride in the configuration. The barrier layer is preferably a laminate structure of the inorganic layer and an organic layer.

The pressure-sensitive adhesive layer may be provided on a side of the member having a higher modulus of elasticity than the pressure-sensitive adhesive layer opposite to the first conductive layer, and the composite member may further includes a pressure-sensitive adhesive layer provided on a side of a second conductive layer opposite to the insulating layer, and the second conductive layer may be provided on a side on which a radius of curvature of the insulating layer is smaller in the case of bending the conductive layer body in a bending direction.

The present invention provides a device comprising: the above-described composite member.

According to the present invention, it is possible to control stress being exerted on a conductive layer.

### BRIEF DESCRIPTION OF THE DRAWINGS

FIG. 1 is a schematic view showing a bilayer composite member.

FIG. 2 is a graph showing stress being exerted in the case of bending the bilayer composite member.

FIG. 3 is a schematic view showing a four-layer composite member.

FIG. 4 is a graph showing stress being exerted in the case of bending the four-layer composite member.

FIG. 5 is a schematic view showing an eight-layer composite member.

FIG. 6 is a graph showing stress being exerted in the case of bending the eight-layer composite member.

FIG. 7 is a schematic view showing a display device having a composite member of an embodiment of the present invention.

FIG. 8 is a schematic plan view showing an example of a touch sensor portion that is used in the display device.

FIG. 9 is a schematic cross-sectional view showing the example of the touch sensor portion that is used in the display device.

FIG. 10 is a plan view showing disposition of conductive wires of the touch sensor portion that is used in the display device.

FIG. 11 is a schematic view showing a different example of the display device having the composite member of the embodiment of the present invention.

FIG. 12 is a schematic cross-sectional view showing a first different example of the touch sensor portion that is used in the display device.

FIG. 13 is a schematic cross-sectional view showing a second different example of the touch sensor portion that is used in the display device.

FIG. 14 is a schematic cross-sectional view showing a third different example of the touch sensor portion that is used in the display device.

FIG. 15 is a schematic perspective view showing a first example of the display device having the composite member of the embodiment of the present invention.

FIG. 16 is a schematic perspective view showing a usage state of the first example of the display device having the composite member of the embodiment of the present invention.

FIG. 17 is a schematic perspective view showing a second example of the display device having the composite member of the embodiment of the present invention.

FIG. 18 is a schematic perspective view showing a usage state of the second example of the display device having the composite member of the embodiment of the present invention.

FIG. 19 is a schematic perspective view showing a third example of the display device having the composite member of the embodiment of the present invention.

### DESCRIPTION OF THE PREFERRED EMBODIMENTS

Hereinafter, a composite member of an embodiment of the present invention will be described in detail on the basis of preferred embodiments shown in the accompanying drawings.

Drawings used in the following description show examples for describing the present invention, and the present invention is not limited to the drawing shown below.

A numerical range expressed using “to” below includes numerical values described on both sides of “to”. For example, an expression “ε is a numerical value α1 to a numerical value β1” indicates that the range ε is a range including the numerical value al and the numerical value β1 and is expressed as α1≤ε≤β1 using numerical symbols.

Unless there is a particular description, an expression regarding an angle such as “an angle expressed using a specific numerical value”, “parallel”, or “orthogonal” includes an error range that is generally permitted in the relevant technical field.

An expression “transparent” indicates that, in a visible light wavelength range of 400 to 800 nm, the light transmittance is at least 60% or higher, preferably 75% or higher, more preferably 80% or higher, and still more preferably 85% or higher. The light transmittance is measured using “Plastics—Determination of Total Luminous Transmittance And Reflectance” regulated by Japanese Industrial Standards (JIS) K7375:2008.

In addition, an expression “flexible” in the present invention means that a substance is foldable and indicates that, specifically, the substance does not crack even in the case of being folded at a radius of curvature of 1 mm.

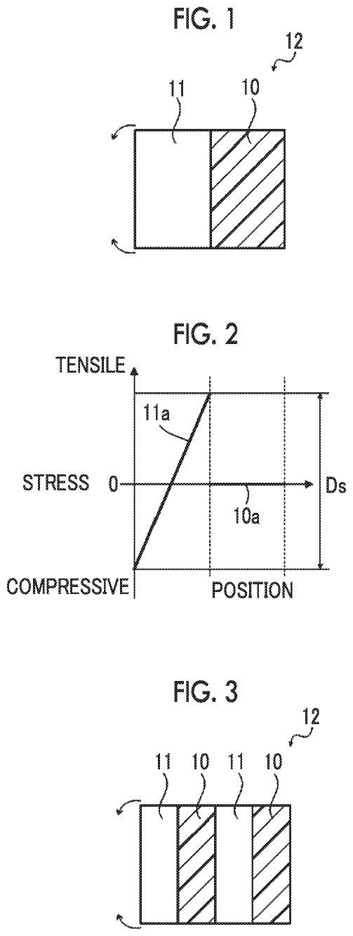

First, as a result of intensive studies, the present inventors found that, in the case of bending a laminate 12 (refer to FIG. 1) in which a member 10 (refer to FIG. 1) having a low modulus of elasticity that is substantially the same as the modulus of elasticity of a transparent pressure-sensitive adhesive film (optically clear adhesive (OCA)) and a member 11 (refer to FIG. 1) having a high modulus of elasticity that is substantially the same as the modulus of elasticity of a plastic film such as polyethylene terephthalate (PET), a cycloolefin polymer (COP), or polyimide (PI) are laminated together so that the member 11 is located inside, as shown in a graph of FIG. 2, it is certain that stress relaxation occurs in the member 10 having a low modulus of elasticity (refer to FIG. 1), that is, the transparent pressure-sensitive adhesive film, and stress of a tensile component and stress of a compressive component are distributed in the member 11, that is, the plastic film. Reference 10a shown in FIG. 2 indicates stress being exerted on the member 10, and Reference 11a indicates stress being exerted on the member 11.

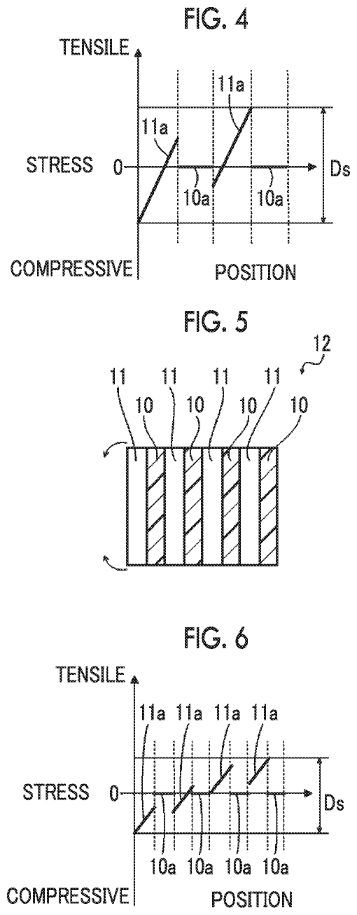

From the above description, it is certain that stress relaxation occurs as long as the modulus of elasticity is not an extremely low modulus of elasticity as in US2015/0201487A but substantially the same modulus of elasticity as the transparent pressure-sensitive adhesive film. Therefore, it is possible to distribute a tensile stress and a compressive stress in each of the layers of the laminate by configuring the laminate 12 (refer to FIG. 1) including the member 10 (refer to FIG. 1) such as the above-described transparent pressure-sensitive adhesive film. It was found that, in the laminate 12 in which a plurality of layers of a cover material and a plurality of layers of a thin transparent pressure-sensitive adhesive film are laminated together as shown in FIG. 3 and FIG. 5, as shown in FIG. 4 and FIG. 6, a stress Ds being exerted on the entire laminate 12 becomes smaller than a stress Ds being exerted on the entire laminate 12 shown in FIG. 2, and folding resistance further improves. This is assumed to result from the fact that stress relaxation occurs in the member 10 such as the transparent pressure-sensitive adhesive film and the tensile stress and the compressive stress are respectively applied to thin layers in a split manner, whereby strains in the respective cover material layers are relieved, and buckling or cutting is not caused.

In FIG. 3 and FIG. 5, the same configurational article as in FIG. 1 is given the same reference and will not be described in detail. In addition, in FIG. 4 and FIG. 6, the same configurational article as in FIG. 2 is given the same reference and will not be described in detail. FIG. 3 shows a laminate in which the members 10 and the members 11 are alternately laminated together in a total of four layers, and FIG. 5 shows a laminate in which the members 10 and the members 11 are alternately laminated together in a total of eight layers.

As a result of carrying out additional studies in consideration of the above description, it was found that, in a conductive layer body including a conductive layer sandwiched by pressure-sensitive adhesive layers, in a case where the conductive layer is configured to be in contact with the pressure-sensitive adhesive layer on an inward fold side and not to be in contact with the pressure-sensitive adhesive layer on an outward fold side, it is possible to improve the folding resistance of the conductive layer. This is because, in a conductive layer body having conductive layers respectively provided on both surfaces of a substrate and sandwiched by pressure-sensitive adhesive layers, a tensile stress is likely to be exerted on an outward fold side, a compressive stress is likely to be exerted on an inward fold side, and the stresses increase toward the pressure-sensitive adhesive layers. That is, the conductive layer is tolerant to a compressive stress but vulnerable to a tensile stress, and thus it is desirable to dispose the conductive layer far from the surface of the pressure-sensitive adhesive layer on the outward fold side and close to the pressure-sensitive adhesive layer on the inward fold side since the folding resistance of the conductive layer is improved. Meanwhile, regarding the inward fold side and the outward fold side, in a case where the conductive layer body is bent in a bending direction, a side on which the radius of curvature of the substrate is small is the inward fold side, and a side on which the radius of curvature of the substrate is large is the outward fold side.

Next, the composite member will be described in detail. The composite member has a conductive layer body having conductive layers respectively provided on both surfaces of a substrate and at least two pressure-sensitive adhesive layers disposed so as to sandwich the conductive layer body. A first conductive layer provided on a surface on which the modulus of elasticity of the substrate is large in the case of bending the conductive layer body in a bending direction is in contact with a member having a higher radius of curvature than the pressure-sensitive adhesive layer. As a device having the composite member, display devices are exemplified, but the device is not limited to display devices as long as the device has a conductive layer body having conductive layers respectively provided on both surfaces of the substrate in the configuration.

Hereinafter, a display device will be described as an example of the device having the composite member.

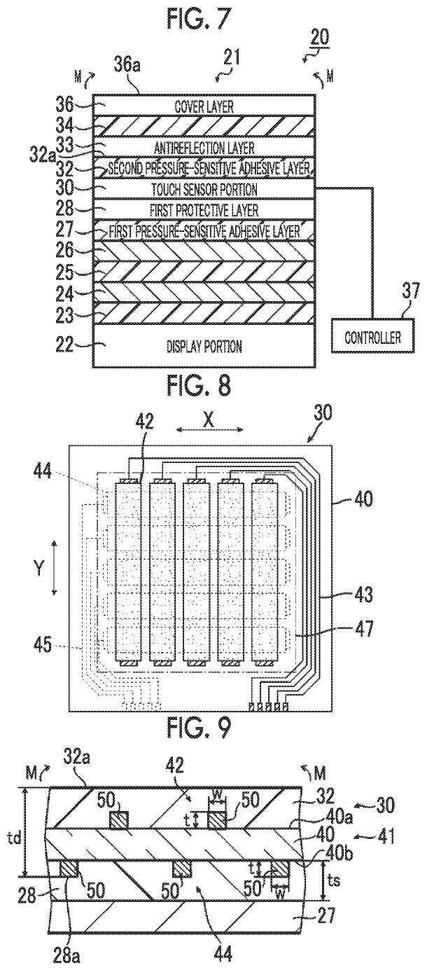

FIG. 7 is a schematic view showing a display device having the composite member of the embodiment of the present invention.

A display device 20 shown in FIG. 7 has a function of detecting touch by a finger or the like. The display device 20 has a display portion 22, a first pressure-sensitive adhesive layer 27, a first protective layer 28, a touch sensor portion 30, a second pressure-sensitive adhesive layer 32, an antireflection layer 33, a cover layer 36, and a controller 37. In the display device 20, a surface 36a of the cover layer 36 is a touch surface that is touched by a finger or the like.

Furthermore, a plastic film 24, a transparent layer 25, and a plastic film 26 are provided between the display portion 22 and the first pressure-sensitive adhesive layer 27. From the display portion 22 side, the plastic film 24, the transparent layer 25, and the plastic film 26 are sequentially provided. In addition, a transparent layer 23 is provided between the plastic film 24 and the display portion 22, and a transparent layer 34 is provided between the antireflection layer 33 and the cover layer 36.

The display device 20 shown in FIG. 7 from which the display portion 22 and the transparent layer 23 are removed is a composite member 21.

The display portion 22 includes a display region (not shown) displaying an image or the like and is configured of, for example, a liquid crystal display panel or an organic electroluminescence (EL) display panel. As the display portion 22, other than the above-described panels, a vacuum fluorescent display (VFD), a plasma display panel (PDP), a surface conduction electron emitter display (SED), a field-emission display (FED), electronic paper, and the like can be used.

The transparent layer 23 and the transparent layer 34 are both optically transparent and insulating, and the configuration thereof is not particularly limited as long as the transparent layers are capable of exhibiting a stabilized fixation force. As the transparent layer 23 and the transparent layer 34, for example, an optical clear adhesive (OCA) and an optical clear resin (OCR) such as an ultraviolet (UV)-curable resin can be used. As the transparent layer 23 and the transparent layer 34, for example, MO-3015C (trade name), MO-3015G (trade name), MO-3015H (trade name), and MO-30151 (trade name) manufactured by Lintec Corporation can be used. The transparent layer 34, similar to the first pressure-sensitive adhesive layer 27 and the second pressure-sensitive adhesive layer 32, configures a pressure-sensitive adhesive layer.

The touch sensor portion 30 detects the touch of the surface 36a of the cover layer 36 by a finger or the like in the display device 20. The touch sensor portion 30 may be a capacitance-type touch sensor or a resistance film-type touch sensor.

As the controller 37, a controller suitable for the touch sensor portion 30 is appropriately used. In a case where the touch sensor portion 30 is a capacitance-type touch sensor, a location at which the electrostatic capacitance has changed is detected by the controller 37. In a case where the touch sensor portion 30 is a resistance film-type touch sensor, a location at which the resistance has changed is detected by the controller 37.

As the touch sensor portion 30, a capacitance-type touch sensor will be described as an example.

As shown in FIG. 8, the touch sensor portion 30 has an insulating substrate 40, detection electrodes respectively formed on both surfaces of one insulating substrate 40, and peripheral wires formed in the peripheries of the detection electrodes and electrically connected to the detection electrodes. The detection electrode corresponds to the conductive layer.

On a front surface 40a (refer to FIG. 9) of the insulating substrate 40, a plurality of first detection electrodes 42 that respectively extends in a first direction Y and is disposed in parallel in a second direction X orthogonal to the first direction Y is formed, and a plurality of first peripheral wires 43 electrically connected to the plurality of first detection electrodes 42 is arranged close to each other. Similarly, on a rear surface 40b (refer to FIG. 9) of the insulating substrate 40, a plurality of second detection electrodes 44 that respectively extends in the second direction X and is disposed in parallel in the first direction Y is formed, and a plurality of second peripheral wires 45 electrically connected to the plurality of second detection electrodes 44 is arranged close to each other. The plurality of first detection electrode 42 and the plurality of second detection electrodes 44 are the detection electrodes. The plurality of first detection electrode 42 and the plurality of second detection electrodes 44 are electrically insulated by the insulating substrate 40 and are disposed so as to be spaced from each other and partially superimpose each other. The insulating substrate 40 functions as the insulating layer that electrically insulates at least two conductive layers and is one form of the insulating layer.

In the touch sensor portion 30, on the insulating substrate 40, a region in which the plurality of first detection electrode 42 and the plurality of second detection electrodes 44 are disposed so as to superimpose each other in a plan view is a detection region 47. The detection region 47 is a region in which touch by a finger or the like can be detected.

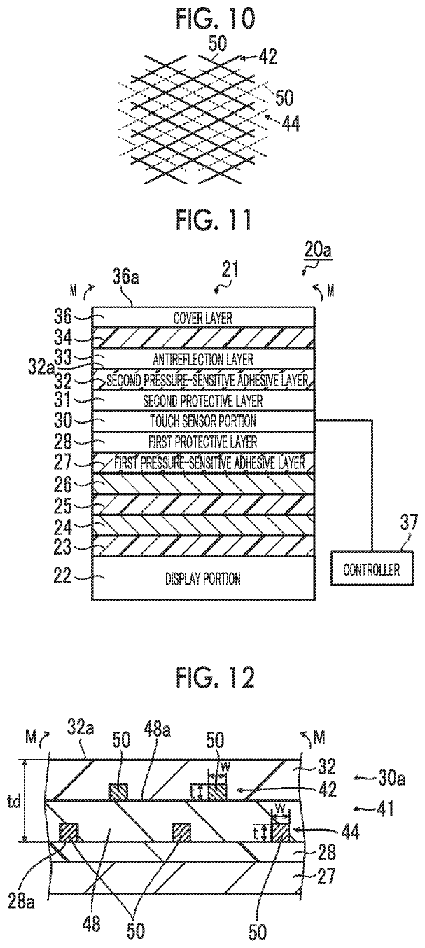

As shown in FIG. 9, the first detection electrode 42 is configured of, for example, a conductive wire 50 formed on the front surface 40a of the insulating substrate 40. The conductive wires 50 of the first detection electrodes 42 are disposed, for example, in a mesh pattern as shown in FIG. 10. As shown in FIG. 9, the second detection electrode 44 is configured of, for example, a conductive wire 50 formed on the rear surface 40b of the insulating substrate 40. The conductive wires 50 of the second detection electrodes 44 are disposed, for example, in a mesh pattern as shown in FIG. 10.

A member in a state in which the conductive wires 50 configuring the first detection electrodes 42 are formed on the front surface 40a of the insulating substrate 40 and the conductive wires 50 configuring the second detection electrodes 44 are formed on the rear surface 40b is a conductive layer body 41. The conductive layer body 41 consists of the insulating substrate 40, the conductive wires 50 configuring the first detection electrodes 42, and the conductive wires 50 configuring the second detection electrodes 44 and preferably does not include any pressure-sensitive adhesive layers in the configuration. The insulating substrate 40 has a higher modulus of elasticity than the pressure-sensitive adhesive layer. In addition, the insulating substrate 40 is preferably flexible since the conductive layer body 41 is bent. The first detection electrode 42 corresponds to the second conductive layer, and the second detection electrode 44 corresponds to the first conductive layer.

In FIG. 9, a front surface 40a side of the insulating substrate 40 on which the radius of curvature is small in the case of bending the conductive layer body 41 in a bending direction M is the inward fold side. A rear surface 40b side of the insulating substrate 40 on which the radius of curvature is large in the case of bending the conductive layer body 41 in the bending direction M is the outward fold side. Therefore, the second detection electrode 44 corresponds to the first conductive layer on the outward fold side, and the first detection electrode 42 corresponds to the second conductive layer on the inward fold side.

The first pressure-sensitive adhesive layer 27 is disposed on the rear surface 40b side of the insulating substrate 40, and the second pressure-sensitive adhesive layer 32 is disposed on the front surface 40a side of the insulating substrate 40.

The first peripheral wires 43 and the second peripheral wires 45 are configured of, for example, the conductive wires 50. There is no particular limitation in configuring the first peripheral wires 43 and the second peripheral wires 45 using the conductive wires 50, and the peripheral wires may be configured of conductive wires that are different from the conductive wire 50 in terms of the wire width, the thickness, and the like. The first peripheral wires 43 and the second peripheral wires 45 can be formed using, for example, a band-shaped conductor. In this case, the plurality of first detection electrode 42 and the plurality of second detection electrode 44 are configured of the conductive wires 50, and the first peripheral wires 43 and the second peripheral wires 45 are formed of other substances.

The touch sensor portion 30 is not limited to the capacitance-type touch sensor and may be a resistance film-type touch sensor. The respective configurational members of the touch sensor portion 30 will be described below.

The antireflection layer 33 has a linear polarizer and a λ/4 plate. In the antireflection layer 33, the polarizer is disposed on a touch sensor portion 30 side, and the λ/4 plate is disposed on a cover layer 36 side. The λ/4 plate refers to a plate having a λ/4 function. The λ/4 plate may be a monolayer-type λ/4 plate or a broadband λ/4 plate in which the λ/4 plate and a λ/2 plate are laminated together.

The thickness of the antireflection layer 33 is not particularly limited, but is preferably 1 to 100 μm and more preferably 1 to 50 μm.

The linear polarizer of the antireflection layer 33 needs to be a member having a function of converting light to specific linearly polarized light, and, mainly, it is possible to use an absorption-type polarizer.

As the absorption-type polarizer, an iodine-based polarizer, a dye-based polarizer using a dichroic dye, a polyene-based polarizer, and the like can be used. The iodine-based polarizers and the dye-based polarizers are classified into coating-type polarizers and stretching-type polarizers, and both types of polarizers can be used, but a polarizer produced by adsorbing iodine or a dichroic dye to a polyvinyl alcohol and stretching the polyvinyl alcohol is preferred.

In addition, as a method for obtaining a polarizer by stretching and dyeing a laminate film having a polyvinyl alcohol layer formed on a base material, JP5048120B, JP5143918B, JP5048120B, JP4691205B, JP4751481B, and JP4751486B can be exemplified, and these well-known techniques regarding polarizers can also be preferably used.

The λ/4 plate is a plate having a function of converting linearly polarized light having a specific wavelength to circularly polarized light or circularly polarized light to linearly polarized light. More specifically, the λ/4 plate is a plate showing an in-plane retardation value of λ/4 (or an odd multiple thereof) at a specific wavelength λ nm.

The in-plane retardation value (Re(550)) of the λ/4 plate at a wavelength of 550 nm may have an error of approximately 25 nm from an ideal value (137.5 nm) and is, for example, preferably 110 to 160 nm, more preferably 120 to 150 nm, and still more preferably 130 to 145 nm.

An angle formed by an absorption axis of the polarizer and an in-plane slow axis of the λ/4 plate is preferably in a range of 45°±3°. In other words, the angle is preferably in a range of 42° to 48°. From the viewpoint of a superior antireflection effect, the angle is preferably in a range of 450±2°.

The above-described angle refers to an angle formed by the absorption axis of the polarizer and the in-plane slow axis of the λ/4 plate in the case of being seen in the normal direction to the surface of the polarizer.

In the case of using the above-described broadband λ/4 plate as the λ/4 plate, it is preferable to use the broadband λ/4 plate in a state in which the λ/4 plate and the λ/2 plate are attached together so that the angle formed by the in-plane slow axis of the λ/4 plate and the in-plane slow axis of the λ/2 plate reaches 60°, a λ/2 plate side is disposed on an incidence side of linearly polarized light, and the in-plane slow axis of the λ/2 plate is caused to intersect at 15° or 75° with respect to the polarization plane of incident linearly polarized light.

The above-described angle refers to an angle formed by the absorption axis of the polarizer and the in-plane slow axis of the λ/4 plate and an angle formed by the absorption axis of the polarizer and the in-plane slow axis of the λ/2 plate respectively in the case of being seen in a normal direction to the surface of the polarizer.

The cover layer 36 plays a role of protecting the touch sensor portion 30 from the external environment. The cover layer 36 is preferably transparent, and a plastic film, a plastic plate, or the like is used. The thickness of the cover layer 36 is desirably appropriately selected depending on individual uses, but is, for example, preferably 1 to 200 μm, more preferably 5 to 150 μm, and still more preferably 30 to 100 μm. In a case where the display device is bent in the bending direction M so that the cover layer 36 is located inside (refer to FIG. 7) and the thickness of the cover layer 36 is 1 μm or more, the cover layer 36 being bent toward the opposite direction by a compressive stress is suppressed, and peeling does not easily occur. In addition, in a case where the thickness of the cover layer 36 is less than 200 μm, peeling does not easily occur, and a compressive stress is also suppressed, and thus buckling also does not easily occur.

As the material of the plastic film and the plastic plate, for example, polyesters such as polyethylene terephthalate (PET) and polyethylene naphthalate (PEN): polyolefins such as polyethylene (PE), polypropylene (PP), polystyrene, and polyethylene-vinyl acetate copolymer (EVA); vinyl-based resins: additionally, polycarbonate (PC), polyamide, polyimide, (meth)acrylic resins, triacetyl cellulose (TAC), cycloolefin-based resins (COP), and the like are exemplified.

As shown in FIG. 3 and FIG. 5, in the case of laminating a plurality of layers, it is possible to relax stress and decrease a tensile stress being exerted, and thus the plastic film 24, the transparent layer 25, and the plastic film 26 are provided between the display portion 22 and the first pressure-sensitive adhesive layer 27. Stress being exerted on the touch sensor portion 30 can be adjusted by providing the above-described members.

The plastic film 24 and the plastic film 26 are preferably formed of, for example, at least one of polyimide (PI), polyamide (PA), polyethylene terephthalate (PET), triacetyl cellulose (TAC), or a cycloolefin copolymer (COC). In addition, the plastic film 24 and the plastic film 26 preferably have a modulus of elasticity of 10⁻¹ to 30 GPa. The modulus of elasticity refers to a tensile modulus of elasticity.

The modulus of elasticity can be measured using a dynamic elastic modulus measurement instrument or a fine hardness tester (PICODENTOR).

The transparent layer 25 has the same configuration as the first pressure-sensitive adhesive layer 27. In addition, the transparent layer 25, similar to the first pressure-sensitive adhesive layer 27 and the second pressure-sensitive adhesive layer 32, configures the pressure-sensitive adhesive layer.

The sticking force in an interface with the respective members that are in contact with the transparent layer or the pressure-sensitive adhesive layer is preferably high from the viewpoint of suppressing peeling. The sticking force in the interface with the respective members that are in contact with the pressure-sensitive adhesive layer is preferably 0.1 N/mm or higher, more preferably 0.4 N/mm or higher, and most preferably 0.7 N/mm or higher.

The first pressure-sensitive adhesive layer 27 and the second pressure-sensitive adhesive layer 32 are, for example, disposed so as to sandwich the touch sensor portion 30. The first protective layer 28 is provided between the touch sensor portion 30 and the first pressure-sensitive adhesive layer 27. At least one pressure-sensitive adhesive layer needs to be provided in the configuration.

The first pressure-sensitive adhesive layer 27 adheres the plastic film 26 and the first protective layer 28 and functions as a stress relaxation layer. In addition, the first pressure-sensitive adhesive layer 27 is disposed on a side on which the radius of curvature of the insulating substrate 40 is large in the case of bending the conductive layer body 41 in the bending direction M, that is, on the outward fold side.

The second pressure-sensitive adhesive layer 32 adheres the touch sensor portion 30 and the antireflection layer 33 and functions as a stress relaxation layer. In addition, the second pressure-sensitive adhesive layer 32 is disposed on a side on which the radius of curvature of the insulating substrate 40 is small in the case of bending the conductive layer body 41 in the bending direction M, that is, on the inward fold side and is in contact with the conductive wires 50 of the first detection electrodes 42 (refer to FIG. 9).

The disposition locations of the pressure-sensitive adhesive layers are not particularly limited as long as at least one pressure-sensitive adhesive layer is disposed at a portion except for between the insulating substrate 40 and the conductive layer and at a portion except for between the first conductive layer and the member having a higher modulus of elasticity than the pressure-sensitive adhesive layer. For example, the pressure-sensitive adhesive layer is disposed on a side opposite to the insulating layer of the first conductive layer like the first pressure-sensitive adhesive layer 27 or disposed on a side opposite to the insulating layer of the second conductive layer provided on a side on which the radius of curvature of the insulating layer is smaller in the case of bending the conductive layer body 41 in the bending direction like the second pressure-sensitive adhesive layer 32. Therefore, the first pressure-sensitive adhesive layer 27 and the second pressure-sensitive adhesive layer 32 are not limited to be disposed so as to sandwich the touch sensor portion 30.

The above description shows that at least one pressure-sensitive adhesive layer is not formed between the insulating substrate 40 and the first detection electrodes 42. That is, the pressure-sensitive adhesive layer is not formed between the front surface 40a of the insulating substrate 40 and the conductive wires 50 of the first detection electrodes 42. Furthermore, the pressure-sensitive adhesive layer is also not formed between the insulating substrate 40 and the second pressure-sensitive adhesive layer 32.

The first pressure-sensitive adhesive layer 27 and the second pressure-sensitive adhesive layer 32 preferably have a modulus of elasticity of 10⁻⁶ to 10⁻² GPa. As the first pressure-sensitive adhesive layer 27 and the second pressure-sensitive adhesive layer 32, for example, MO-3015C (trade name), MO-3015G (trade name), MO-3015H (trade name), and MO-30151 (trade name) manufactured by Lintec Corporation can be used. The modulus of elasticity refers to a tensile modulus of elasticity. Even in this case, the modulus of elasticity can be measured using a dynamic elastic modulus measurement instrument or a fine hardness tester (PICODENTOR).

The first protective layer 28 is intended to prevent the direct contact between the first pressure-sensitive adhesive layer 27 and the second detection electrodes 44 that are the conductive layer in the configuration in order to decrease a tensile stress being exerted on the touch sensor portion 30. The first protective layer 28 is laminated on the second detection electrodes 44 provided on the rear surface 40b of the insulating substrate 40 of the conductive layer body 41. In addition, the first protective layer 28 is in contact with the first pressure-sensitive adhesive layer 27.

The first protective layer 28 is a member having a high modulus of elasticity than the first pressure-sensitive adhesive layer 27 and the second pressure-sensitive adhesive layer 32, and the modulus of elasticity is, for example, 10⁻¹ to 30 GPa. The modulus of elasticity refers to a tensile modulus of elasticity. Even in this case, the modulus of elasticity can be measured using a dynamic elastic modulus measurement instrument or a fine hardness tester (PICODENTOR) as described above.

The film thickness of the first protective layer 28 is preferably thin since an excessively thick total film thickness increases the absolute value of stress being applied to the member. On the other hand, in a case where the film thickness of the first protective layer 28 is too thin, an effect for decreasing the above-described tensile stress becomes weak.

Here, a thickness from an interface between the first protective layer 28 and the first conductive layer, that is, an interface 28a (refer to FIG. 9) between the first protective layer 28 and the conductive wires 50 of the second detection electrodes 44 to an interface of the pressure-sensitive adhesive layer that is first disposed on the side on which the radius of curvature of the insulating substrate 40 is small in the case of bending the conductive layer body 41 in the bending direction M (refer to FIG. 9), that is, an interface 32a (refer to FIG. 9) between the second pressure-sensitive adhesive layer 32 and the antireflection layer 33 is represented by td (refer to FIG. 9). In addition, the thickness of the first protective layer 28 is represented by ts (refer to FIG. 9).

The thickness ts (refer to FIG. 9) of the first protective layer 28 is preferably 1/20 or more of the above-described thickness td and more preferably 1/10 or more.

Particularly, in the case of a configuration in which the first protective layer 28 is in contact with the first pressure-sensitive adhesive layer 27, in a case where the first protective layer 28 is approximately as thick as a thickness from the conductive layer on the outward fold side to the pressure-sensitive adhesive layer on the inward fold side, that is, approximately the same as the thickness td, it is possible to sufficiently decrease a force such as a tensile force being applied to the second detection electrodes 44. This fact shows that the thickness ts (refer to FIG. 9) of the first protective layer 28 is preferably ts≤td.

The thickness td can be obtained as described below. First, a cross-sectional electron microscope image including the first pressure-sensitive adhesive layer 27, the first protective layer 28, the conductive layer body 41, and the antireflection layer 33 in the composite member 21 is acquired using a scanning electron microscope. Next, the interface 28a (refer to FIG. 9) between the first protective layer 28 and the conductive wires 50 of the second detection electrodes 44 and the interface 32a (refer to FIG. 9) between the second pressure-sensitive adhesive layer 32 and the antireflection layer 33 are specified from the cross-sectional electron microscope image. Next, the distance between the interface 28a and the interface 32a is measured, and the thickness td is obtained.

A base material, an adhesive material, or the like having a modulus of elasticity of 10⁻¹ to 30 GPa may be disposed instead of the first protective layer 28. The modulus of elasticity refers to a tensile modulus of elasticity. Even in this case, the modulus of elasticity can be measured using a dynamic elastic modulus measurement instrument or a fine hardness tester (PICODENTOR) as described above.

In the case of configuring the composite member 21 as described above, it is possible to adjust stress being exerted on the conductive wires 50 of the conductive layer body 41 and decrease the tensile stress being exerted on the conductive wires 50. Therefore, it is possible to suppress the damage such as the fracture or the like of the conductive wires 50 and obtain sufficient folding resistance. Therefore, it is possible to suppress the degradation of touch sensitivity which detects touch by a finger or the like even in the case of repeatedly bending the display device 20 in the bending direction M so that the surface 36a of the cover layer 36 is located inside.

The total film thickness is preferably thin since a thick total film thickness of the composite member 21 increases the absolute value of stress being applied to the member. The total film thickness of the composite member 21 is preferably 500 μm or smaller and or more preferably 300 μm or smaller.

As a method for increasing the strength of the conductive layer against stress, it is also desirable to install a protective layer on the surface. In this case, a second protective layer 31 is provided between the touch sensor portion 30 and the second pressure-sensitive adhesive layer 32 in the configuration as in a display device 20a shown in FIG. 11. The second protective layer 31 is disposed on the front surface 40a side of the insulating substrate 40 (refer to FIG. 9) on which the radius of curvature is small in the case of bending the conductive layer body 41 (refer to FIG. 9) in the bending direction M (refer to FIG. 9). The second protective layer 31 is in contact with the second pressure-sensitive adhesive layer 32.

In the display device 20a shown in FIG. 11, the same configurational article as in the display device 20 shown in FIG. 7 is given the same reference and will not be described in detail. The display device 20a shown in FIG. 11 from which the display portion 22 and the transparent layer 23 are removed is the composite member 21.

The second protective layer 31 is intended to increase the strengths of the first detection electrodes 42 and the second detection electrodes 44 of the touch sensor portion 30 as described above. The second protective layer 31 can be configured in the same manner as the first protective layer 28. In addition, the modulus of elasticity of the second protective layer 31 is desirably high and preferably 0.1 GPa or higher. The second protective layer 31, as a material, preferably has a crosslinking structure, and the second protective layer 31 is preferably formed of an acrylic resin or a urethane resin.

In a case where the film thickness is thick, the absolute value of stress being applied to the first detection electrodes 42 and the second detection electrodes 44 of the touch sensor portion 30 increases, and thus the thickness of the second protective layer 31 is preferably 20 μm or smaller.

The film thickness of the second protective layer 31 can be obtained by measuring the thickness of the second protective layer 31 before the production of the composite member 21 and can also be measured using a cross-sectional electron microscope image as described above.

The display device 20a shown in FIG. 11 is capable of obtaining the same effect as that of the display device 20 shown in FIG. 7 except for the above-described fact.

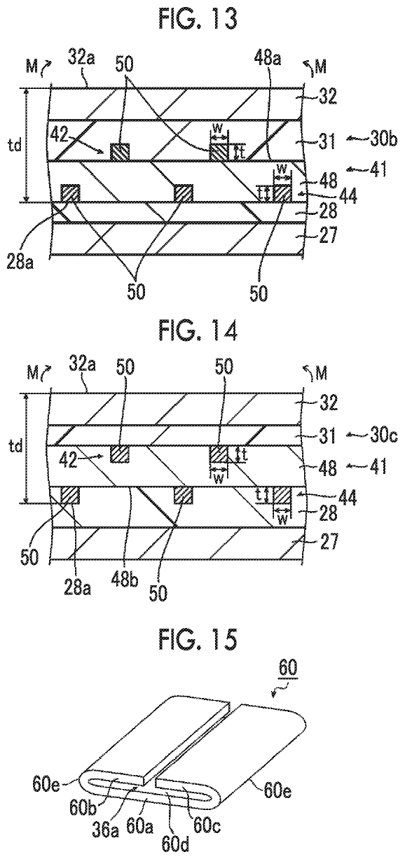

FIG. 12 is a schematic cross-sectional view showing a first different example of the touch sensor portion that is used in the display device, FIG. 13 is a schematic cross-sectional view showing a second different example of the touch sensor portion that is used in the display device, and FIG. 14 is a schematic cross-sectional view showing a third different example of the touch sensor portion that is used in the display device.

The same configurational article as in the display device 20 shown in FIG. 7 and the touch sensor portion 30 shown in FIG. 9 is given the same reference and will not be described in detail.

A touch sensor portion 30a shown in FIG. 12 is different from the touch sensor portion 30 shown in FIG. 9 in terms of the fact that an insulating layer 48 is used instead of the insulating substrate 40 and the first detection electrodes 42 and the second detection electrodes 44 are electrically insulated from each other by the insulating layer 48 and are disposed to be spaced from each other. In addition, the second detection electrodes 44 are formed on the first protective layer 28. Another difference is that the first detection electrodes 42 are formed on a front surface 48a of the insulating layer 48. The first protective layer 28 is formed of, for example, a sheet body and can be configured of the same substrate as the above-described insulating substrate 40.

In addition, a second pressure-sensitive adhesive layer 32 that covers the first detection electrodes 42 is provided on the front surface 48a of the insulating layer 48.

The touch sensor portion 30a shown in FIG. 12 is capable of obtaining the same effect as that of the touch sensor portion 30 shown in FIG. 9.

The touch sensor portion 30a in which the insulating layer 48 is used can also be configured, similar to the display device 20a shown in FIG. 11, to have the second protective layer 31. In this case, as in the touch sensor portion 30b shown in FIG. 13, the second protective layer 31 that covers the first detection electrodes 42 is provided on the front surface 48a of the insulating layer 48. The touch sensor portion 30b shown in FIG. 13 is capable of obtaining the same effect as that of the touch sensor portion 30 shown in FIG. 9.

In both the touch sensor portion 30a shown in FIG. 12 and the touch sensor portion 30b shown in FIG. 13, the first detection electrodes 42 and the second detection electrodes 44 are disposed on the inward fold side in the case of bending the conductive layer body 41 in the bending direction M.

In addition, as a configuration having the second protective layer 31, the touch sensor portion can also be configured like a touch sensor portion 30c shown in FIG. 14. In the touch sensor portion 30c shown in FIG. 14, the insulating layer 48 is used as in the touch sensor portion 30b shown in FIG. 13. The second detection electrodes 44 are provided on a rear surface 48b of the insulating layer 48, and the first protective layer 28 that covers the second detection electrodes 44 is provided on the rear surface 48b of the insulating layer 48.

The first detection electrodes 42 are provided on the second protective layer 31. The second protective layer 31 is formed of, for example, a sheet body and can be configured of the same substrate as the above-described insulating substrate 40.

The touch sensor portion 30c shown in FIG. 14 is capable of obtaining the same effect as that of the touch sensor portion 30 shown in FIG. 9.

In the touch sensor portion 30c shown in FIG. 14, the first detection electrodes 42 and the second detection electrodes 44 are disposed on the outward fold side in the case of bending the conductive layer body 41 in the bending direction M.

As long as the composite member has a configuration in which a conductive layer body including an insulating layer and at least two conductive layers that are electrically insulated by the insulating layer and disposed to be spaced from each other, at least one pressure-sensitive adhesive layer, and a member being in contact with, out of the at least two conductive layers, a first conductive layer provided on a side on which the radius of curvature of the insulating layer is larger in the case of bending the conductive layer body in a bending direction and having a higher modulus of elasticity than the pressure-sensitive adhesive layer are provided, at least one pressure-sensitive adhesive layer is disposed at a portion except for between the insulating layer and the conductive layer and at a portion except for between the first conductive layer and the member having a higher modulus of elasticity than the pressure-sensitive adhesive layer, and the insulating layer has a higher modulus of elasticity than the pressure-sensitive adhesive layer, the device is not limited to the display devices 20 and 20a having the above-described touch sensor portion 30, 30a, 30b, or 30c. For example, the device may be a device having, as the conductive layer, wire substrates on which a wire is formed on both surfaces of a substrate or a device having, as the conductive layer, thin film transistors on which an electron element is formed on both surfaces of a substrate.

Both the display device 20 having the configuration shown in FIG. 7 and the display device 20a having the configuration shown in FIG. 11 are disposed on the side on which the radius of curvature is large in the case of bending the display portion 22 in the bending direction M, but the display portion 22 is preferably disposed on the side on which the radius of curvature is large. In addition, both the display device 20 having the configuration shown in FIG. 7 and the display device 20a having the configuration shown in FIG. 11 are preferably used in a state of being bent in a predetermined direction like the above-described bending direction M. In a case where the bending direction is predetermined, it is not preferable to use the display device in a state of being bent in directions other than the bending direction.

Next, other examples of the display device in which the composite member is used will be described.

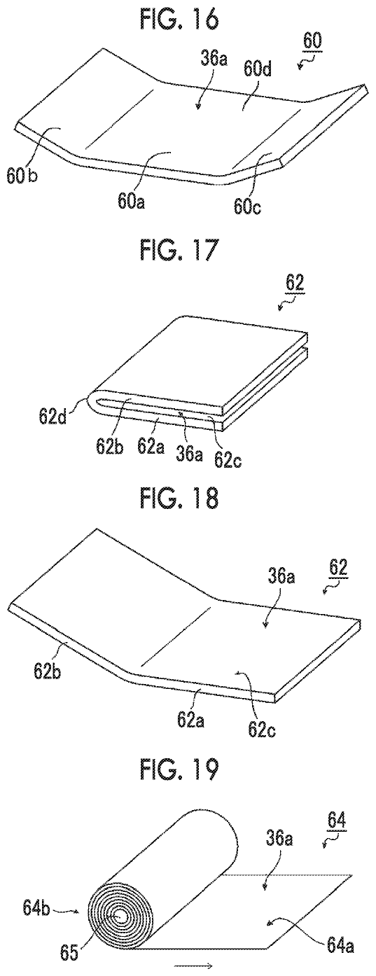

FIG. 15 is a schematic perspective view showing a first example of the display device having the composite member of the embodiment of the present invention, and FIG. 16 is a schematic perspective view showing a usage state of the first example of the display device having the composite member of the embodiment of the present invention. In FIG. 15 and FIG. 16, the same configurational article as in FIG. 7 is given the same reference and will not be described in detail.

The display device 20 having the configuration shown in FIG. 7 and the display device 20a having the configuration shown in FIG. 11 can be configured to, for example, be foldable like a display device 60 shown in FIG. 15. The display device 60 has the same configuration as the display device 20 although not shown in detail. A display region 60d of the display device 60 corresponds to the surface 36a of the cover layer 36. The display device 60 is divided into a central portion 60a, a first side portion 60b, and a second side portion 60c. The display device 60 has a double-doored structure. FIG. 15 shows a state in which the first side portion 60b and the second side portion 60c are folded to come close to the central portion 60a. In this case, in an end portion 60e, the display region 60d is folded to be located inside. The display device 60, similar to the display device 20, has folding resistance, and thus the touch sensitivity of the touch sensor portion 30 does not degrade even in the case of repeatedly opening and closing the first side portion 60b and the second side portion 60c.

In the display device 60, in a case where the entire area of the display region 60d is used, a state in which the first side portion 60b and the second side portion 60c are opened is formed as shown in FIG. 16. It is also possible to use the display region in a state in which any one of the first side portion 60b and the second side portion 60c is opened.

FIG. 17 is a schematic perspective view showing a second example of the display device having the composite member of the embodiment of the present invention, and FIG. 18 is a schematic perspective view showing a usage state of the second example of the display device having the composite member of the embodiment of the present invention. In FIG. 17 and FIG. 18, the same configurational article as in FIG. 7 is given the same reference and will not be described in detail.

The display device 20 having the configuration shown in FIG. 7 and the display device 20a having the configuration shown in FIG. 11 can be configured to, for example, be foldable like a display device 62 shown in FIG. 17. The display device 62 has the same configuration as the display device 20 although not shown in detail. A display region 62c of the display device 62 corresponds to the surface 36a of the cover layer 36. The display device 62 is divided into a first side portion 62a and a second side portion 62b. The display device 62 has a single-doored structure. FIG. 17 shows a state in which the first side portion 62a and the second side portion 62b are folded over each other. In this case, in an end portion 62d, the display region 62c is folded to be located inside. The display device 62, similar to the display device 20, has folding resistance, and thus the touch sensitivity of the touch sensor portion 30 does not degrade.

In the display device 62, in a case where the display region 62c is used, a state in which the first side portion 62a and the second side portion 62b are opened is formed as shown in FIG. 18.

FIG. 19 is a schematic perspective view showing a third example of the display device having the composite member of the embodiment of the present invention. In FIG. 19, the same configurational article as in FIG. 7 is given the same reference and will not be described in detail.

The display device 20 having the configuration shown in FIG. 7 and the display device 20a having the configuration shown in FIG. 11 can be wound around a winding core 65 like a display device 64 shown in FIG. 19. The display device 64 has the same configuration as the display device 20 although not shown in detail. A display region 64a of the display device 64 corresponds to the surface 36a of the cover layer 36. The display device 64 is wound around the winding core 65 so that the display region 64 is located inside. The display device 64, similar to the display device 20, has folding resistance, and thus the touch sensitivity of the touch sensor portion 30 does not degrade. In the display device 64, in a case where the display region 64a is used, the display device 64 is unwound.

Hereinafter, the touch sensor portion 30 will be described.

<Insulating Substrate>

The kind of the insulating substrate 40 is not particularly limited as long as the insulating substrate is capable of electrically insulating the first detection electrodes 42 and the second detection electrodes 44 and can be disposed to be spaced from each other. The insulating substrate 40 is preferably a transparent base material and more preferably a plastic film.

As specific examples of a material configuring the insulating substrate 40, triacetyl cellulose (TAC), polyethylene terephthalate (PET), polyimide (PI), polycycloolefin (COP), a polycycloolefin copolymer (COC), polycarbonate, a (meth)acrylic resin, polyethylene naphthalate (PEN), polyethylene (PE), polypropylene (PP), polystyrene, polyvinyl chloride, or polyvinylidene chloride is preferred. TAC, PET, PI, COP or COC is more preferred, and PET or COP is still more preferred. “(Meth)acrylic” indicates both or any of acrylic and methacrvlic.

The melting point of the plastic film is preferably approximately 290° C. or lower.

The total light transmittance of the insulating substrate 40 is preferably 85% to 100%.

The thickness of the insulating substrate 40 is not particularly limited and, generally, can be randomly selected from a range of 25 to 500 μm. In this range, the thickness of the insulating substrate 40 is preferably 25 to 80 μm, more preferably 25 to 60 μm, and still more preferably 25 to 40 μm since a thin thickness of the insulating substrate 40 is suitable for bending.

As another preferred aspect of the insulating substrate 40, the insulating substrate preferably has an undercoat layer including a polymer on a surface. Formation of a conductive portion on this undercoat layer further improves the adhesiveness of the conductive portion.

A method for forming the undercoat layer is not particularly limited, and, for example, a method in which a composition for forming the undercoat layer including a polymer is applied onto the insulating substrate 40 and a heating treatment is carried out as necessary is exemplified. The composition for forming the undercoat layer may also include a solvent. The kind of the solvent is not particularly limited, and well-known solvents are exemplified. In addition, as the composition for forming the undercoat layer including a polymer, latex including the fine particles of a polymer may also be used.

The thickness of the undercoat layer is not particularly limited, but is preferably 0.02 to 0.3 μm and more preferably 0.03 to 0.2 μm since the adhesiveness of the conductive portion is superior.

In addition, the insulating substrate 40 has a higher modulus of elasticity than the pressure-sensitive adhesive layer as described above, and the modulus of elasticity is preferably 10⁻¹ to 30 GPa. The modulus of elasticity refers to a tensile modulus of elasticity. The modulus of elasticity can be measured using a dynamic elastic modulus measurement instrument or a fine hardness tester (PICODENTOR).

In addition, the insulating substrate 40 is one form of the insulating layer that electrically insulates the conductive layer as described above. The insulating layer is not limited to a sheet-shaped member such as a substrate like the insulating substrate 40 and may have a form of a film or a layer such as an applied film. Even in the case of a film or a layer such as an applied film, similar to the insulating substrate 40, the insulating layers are capable of electrically insulating the first detection electrodes 42 and the second detection electrodes 44 and disposing the detection electrodes to be separated from each other.

<Conductive Wire>

A wire width w of the conductive wire 50 is not particularly limited, but is preferably 30 μm or smaller, more preferably 15 μm or smaller, still more preferably 10 μm or smaller, particularly preferably 9 μm or smaller, and most preferably 7 μm or smaller and preferably 0.5 μm or larger and more preferably 1.0 μm or larger. In the above-described range, it is possible to relatively easily form an electrode having a low resistance.

In a case where the conductive wire is applied as a lead-out wire, the wire width of the conductive wire is preferably 500 μm or smaller, more preferably 50 μm or smaller, and still more preferably 30 μm or smaller. In the above-described range, it is possible to relatively easily form a touch panel electrode having a low resistance.

A thickness t of the conductive wire 50 is not particularly limited, but is preferably 0.001 mm to 0.2 mm, more preferably 30 μm or smaller, still more preferably 20 μm or smaller, particularly preferably 0.01 to 9 μm, and most preferably 0.05 to 5 μm. In the above-described range, it is possible to relatively easily form an electrode having a low resistance and excellent durability.

Regarding the measurement of the width w and thickness t of the conductive wire 50, first, a cross-sectional electron microscope image of the conductive wire 50 is acquired using a scanning electron microscope. Next, the width w and thickness t of the conductive wire 50 are obtained from the cross-sectional electron microscope image.

The pattern consisting of the conductive wires 50 is not limited to a mesh shape and may be a triangular shape such as an equilateral triangular shape, an isosceles triangular shape, or a right triangular shape, a quadrilateral shape such as a square shape, a rectangular shape, a rhombic shape, a parallelogram shape, or a trapezoidal shape, a (regular) n-gonal shape such as a (regular) hexagonal shape or a (regular) octagonal shape, or a geometric configuration obtained by combining a circle, an ellipse, a star shape, and the like.

The mesh shape refers to a shape including a plurality of opening portions (grids) configured of the intersecting conductive wires 50 as shown in FIG. 10. The opening portion refers to an open region surrounded by the conductive wires 50.

The length of one side of the opening portion is preferably 800 μm or shorter, more preferably 600 μm or shorter, and still more preferably 400 μm or shorter and preferably 5 μm or longer, more preferably 30 μm or longer, and still more preferably 80 μm or longer.

From the viewpoint of the visible light transmittance, the opening ratio is preferably 85% or more, more preferably 90% or more, and still more preferably 95% or more. The opening ratio corresponds to the proportion of transmittable portions except for the conductive wires 50 on the front surface 40a of the insulating substrate 40 in the entire front surface 40a.

The configuration of the conductive wire 50 is not particularly limited as long as the conductive wire has a conductive property and functions as a conductive layer. The conductive wire 50 is preferably formed of a metal or an alloy. In a case where the conductive wire 50 is formed of a metal, silver, aluminum, molybdenum, copper, titanium, gold, or tungsten is preferred, and, particularly, silver is more preferred since the conductive property of the conductive wire is excellent. Additionally, for the conductive wire 50, it is possible to use a carbonaceous conductive material such as a carbon nanotube (CNT) or a carbon nanobud (CNB) and a conductive oxide such as indium tin oxide (ITO) or SnO₂. A tensile stress being exerted on the conductive layer can be reduced, and thus the conductive wire 50 is capable of obtaining sufficient folding resistance even in the case of using a carbonaceous conductive material or a conductive oxide other than metal.

The conductive wire 50 preferably includes a binder from the viewpoint of adhesiveness between the conductive wire 50 and the insulating substrate 40.

As the binder, a resin is preferred since the adhesiveness between the conductive wire 50 and the insulating substrate 40 is superior, and, more specifically, at least any resin selected from the group consisting of a (meth)acrylic resin, a styrene-based resin, a vinyl-based resin, a polyolefin-based resin, a polyester-based resin, a polyurethane-based resin, a polyamide-based resin, a polycarbonate-based resin, a polydiene-based resin, an epoxy-based resin, a silicone-based resin, a cellulose-based polymer, and a chitosan-based polymer, a copolymer consisting of a monomer configuring the above-described resins, and the like are exemplified.

A method for manufacturing the conductive wire 50 is not particularly limited, and a well-known method can be employed. For example, a method in which a resist pattern is formed by exposing and developing a photoresist film on a metallic foil formed on a surface of the insulating substrate 40 and the metallic foil exposed from the resist pattern is etched is exemplified. In addition, a method in which printing is carried out on each of both surfaces of the insulating substrate 40 using a paste including a fine metal particle or a metal nanowire and metal plating is carried out on the paste is exemplified.

Furthermore, in addition to the above-described methods, a method in which silver halide is used is exemplified. More specifically, a method described in Paragraphs 0056 to 0114 of JP2014-209332A is exemplified.

From the viewpoint of excellency in bending, a silver fine wire is used as the conductive wire 50, and an aspect including a mesh pattern consisting of the silver fine wire is exemplified.

Any of the above-described touch sensor portions 30 can be configured to have a barrier layer (not shown) having a moisture-shielding capability. In the case of providing a barrier layer in the touch sensor portion 30, it is possible to maintain the moisture-shielding capability without thickening the total film thickness of the composite member.

[Barrier Layer]

The barrier layer has at least one inorganic layer and is preferably a laminate structure of an organic layer and an inorganic layer. The barrier layer may be a laminate in which two or more organic layers and two or more inorganic layers are alternately laminated together. The number of layers configuring the barrier layer is not particularly limited: however, typically, preferably 2 to 30 and more preferably 3 to 20.

As a preferred example of the barrier layer, barrier layers respectively having a configuration in which an organic layer and an inorganic layer are provided in this order from the substrate; a configuration in which an inorganic layer, an organic layer, and an inorganic layer are provided in this order from the substrate; a configuration in which an organic layer, an inorganic layer, and an organic layer are provided in this order from the substrate; a configuration in which an organic layer, an inorganic layer, an organic layer, and an inorganic layer are provided in this order from the substrate; a configuration in which an inorganic layer, an organic layer, an inorganic layer, an organic layer, and an inorganic layer are provided in this order from the substrate: and a configuration in which an organic layer, an inorganic layer, an organic layer, an inorganic layer, and an organic layer are provided in this order from the substrate are exemplified.

A layer in the barrier layer closest to the substrate is preferably directly formed on a surface of the substrate. In a case where, for example, the pressure-sensitive adhesive layer is provided between the barrier layer and the substrate, the pressure-sensitive adhesive layer absorbs moisture, and thus durability is degraded, and an increase in the film thickness also degrades folding resistance. Therefore, the pressure-sensitive adhesive layer is preferably not provided between the barrier layer and the substrate.

In addition, the barrier layer may include configurational layers other than the organic layer and the inorganic layer.

The thickness of the barrier layer is preferably 0.5 μm to 15 μm and more preferably 1 μm to 10 μm.

The barrier layer may also include a so-called gradient material layer in which a composition configuring the barrier layer continuously change into an organic region and an inorganic region in the thickness direction. Particularly, the gradient material layer can be included between a specific organic layer and an inorganic layer that is directly formed on the surface of the organic layer. As an example of the gradient material layer, a material described in a thesis by Kimura “Journal of Vacuum Science and Technology A Vol. 23 pp. 971 to 977 (2005, American Vacuum Society)”, a continuous layer in which an organic region and an inorganic region do not have an interface as disclosed in the specification of US2004/046497A, and the like are exemplified. Hereinafter, for simplification, the organic layer and the organic region will be expressed as “organic layer”, and the inorganic layer and the inorganic region will be expressed as “inorganic layer”.

<Inorganic Layer>

The inorganic layer includes a metallic compound. The inorganic layer needs to be a layer mainly contributing to the barrier property of a composite film.

The amount of the metallic compound in the inorganic layer needs to be 90% by mass or more and is preferably 95% by mass or more, more preferably 99% by mass or more, and still more preferably 99.90/o by mass or more of the total mass of the inorganic layer. The inorganic layer may substantially consist of the metallic compound.

As the metallic compound, a metallic oxide, a metallic nitride, a metallic carbide, a metallic oxynitride, or a metallic oxycarbide is exemplified. For example, as the metallic compound, it is possible to preferably use an oxide, a nitride, a carbide, an oxynitride, an oxycarbide, or the like including one or more metals selected from Si, Al, In, Sn, Zn, Ti, Cu, Ce. and Ta. Among these, an oxide, a nitride, or an oxynitride of a metal selected from Si, Al, In, Sn, Zn, and Ti is preferred, and, particularly, an oxide, a nitride, or an oxynitride of Si or Al is preferred. The above-described metallic compound may contain, as a collateral component, other elements. For example, the metallic compound may include hydrogen. In addition, the metallic compound may become a nitride or the like having a hydroxyl group.

As the inorganic layer, particularly, a layer including Si is preferred. This is because the layer including Si is more highly transparent and has a superior barrier property. Particularly, a layer including a silicon nitride is preferred.

The barrier layer includes at least one layer including silicon nitride as the inorganic layer. In the layer including silicon nitride, the amount of silicon nitride is preferably 60% by mass or more, more preferably 70% by mass or more, still more preferably 80% by mass or more, and particularly preferably 90% by mass or more of the total mass of the layer including silicon nitride.

In the case of including a plurality of inorganic layers, metallic compounds configuring the plurality of inorganic layers may be identical to or different from each other, but are preferably identical to each other. That is, in a case where the barrier layer includes a plurality of inorganic layers, all of the plurality of inorganic layers is preferably the layer including silicon nitride.

On the basis of the fact that the oxide, nitride, or oxynitride of a metal includes hydrogen, the inorganic layer may include hydrogen, and the concentration of hydrogen in forward Rutherford scattering is preferably 30% or less.

Regarding the flatness of the inorganic layer, the 1 μm×1 μm average roughness (Ra value) is preferably less than 3 nm and more preferably 1 nm or less.

A method for forming the inorganic layer may be any method as long as the method is capable of forming a thin film. As an example of the method for forming the inorganic layer, physical vapor deposition methods (PVD) such as a deposition method, a sputtering method, and an ion-plating method, a variety of chemical deposition methods (CVD) such as a thermal CVD method, a light CVD method, and a plasma CVD method, liquid phase growth methods such as a plating method or a sol-gel method, and the like are exemplified. In a case where the barrier layer includes a plurality of inorganic layers, methods for forming the plurality of inorganic layers may be identical to or different from each other and are preferably identical to each other.

The inorganic layer is preferably directly formed on a surface of a substrate or an organic layer described below.

The thickness of the inorganic layer is not particularly limited; however, generally, per layer, is in a range of 5 to 500 nm, preferably 10 to 200 nm, and more preferably 15 to 50 nm.

<Organic Layer>

The barrier layer includes at least one organic layer. In the barrier layer, the organic layer is preferably in direct contact with at least one inorganic layer.

The organic layer can be preferably formed by curing a polymerizable composition including a polymerizable compound.

(Polymerizable Compound)

The polymerizable compound is preferably a compound having an ethylenically unsaturated bond at a terminal or a side chain and/or a compound having epoxy or oxetane at a terminal or a side chain. The polymerizable compound is particularly preferably a compound having an ethylenically unsaturated bond at a terminal or a side chain. As an example of the compound having an ethylenically unsaturated bond at a terminal or a side chain, a (meth)acrylate-based compound, an acrylamide-based compound, a styrene-based compound, a maleic anhydride, and the like are exemplified, a (meth)acrylate-based compound is preferred, and an acrylate-based compound is particularly preferred.

As the (meth)acrylate-based compound, (meth)acrylate, urethane (meth)acrylate, polyester (meth)acrylate, epoxy (meth)acrylate, and the like are preferred.

As the styrene-based compound, styrene, α-methylstyrene, 4-methylstyrene, divinylbenzene, 4-hydroxystyrene, 4-carboxystyrene, and the like are preferred.

As the (meth)acrylate-based compound, specifically, it is possible to use, for example, compounds described in Paragraphs 0024 to 0036 of JP2013-043382A or in Paragraphs 0036 to 0048 of JP2013-043384A. In addition, polyfunctional acrylic monomers having a fluorene skeleton such as a compound of a formula represented by Formula (2) described in WO2013/047524 can also be used.

(Polymerization Initiator)

The polymerizable composition for forming the organic layer may include a polymerization initiator. In the case of using a polymerization initiator, the content thereof is preferably 0.1% by mol or more and more preferably 0.5% to 5% by mol of the total amount of a compound participating to polymerization. In the case of formulating the composition as described above, it is possible to appropriately control a polymerization reaction which goes through an active component generation reaction. As an example of a photopolymerization initiator, IRGACURE series (for example, IRGACURE 651, IRGACURE 754, IRGACURE 184, IRGACURE 2959, IRGACURE 907, IRGACURE 369, IRGACURE 379, IRGACURE 819, and the like), DAROCURE series (for example, DAROCURE TPO, DAROCURE 1173, and the like), QUANTACURE PDO, all of which are made to be commercially available by BASF, EZACURE series (for example, EZACURE TZM, EZACURE TZT, EZACURE KTO46, and the like) made to be commercially available by Lamberti S.p.A, and the like are exemplified.

(Silane Coupling Agent)

The polymerizable composition for forming the organic layer may include a silane coupling agent. As the silane coupling agent, a silane coupling agent having, together with a hydrolysable reactive group such as a methoxy group, an ethoxy group, or an acetoxy group which bonds to silicon, a substituent having one or more reactive groups selected from an epoxy group, a vinyl group, an amino group, a halogen group, a mercapto group, and a (meth)acryloyl group as a substituent bonding to the same silicon is preferred. The silane coupling agent particularly preferably has a (meth)acryloyl group. As a specific example of the silane coupling agent, a silane coupling agent represented by General Formula (1) described in WO2013/146069, a silane coupling agent represented by General Formula (I) described in WO2013/027786, and the like are exemplified.

The proportion of the silane coupling agent in the solid content (residue after the volatilization of a volatile component) of the polymerizable composition is preferably 0.1% to 30% by mass and more preferably 1% to 20% by mass.

(Method for Producing Organic Layer)

For the production of the organic layer, first, the polymerizable composition is turned into a lamellar shape. In order to turn the polymerizable composition into a lamellar shape, generally, the polymerizable composition is applied onto a support such as a substrate or the inorganic layer. As an application method, a dip coating method, an air knife coating method, a curtain coating method, a roller coating method, a wire bar coating method, a gravure coating method, a stride coating method, or an extrusion coating method (also referred to as a die coating method) in which a hopper is used described in the specification of U.S. Pat. No. 2,681,294A is exemplified, and, among these, an extrusion coating method can be preferably employed.

In the case of applying the polymerizable composition for forming the organic layer on the surface of the inorganic layer, the polymerizable composition is preferably applied using an extrusion coating method.

The applied polymerizable composition may be, subsequently, dried.

The polymerizable composition may be cured using light (for example, an ultraviolet ray), an electron beam, or a heat ray and is preferably photo-cured. Particularly, the polymerizable composition is preferably cured while being heated at a temperature of 25° C. or higher (for example, 30° C. to 130° C.). Heating accelerates the free motion of the polymerizable composition, whereby the polymerizable composition is effectively cured, and it is possible to form a film configuring a substrate without causing any damage on the film or the like.

Light being radiated may be an ultraviolet ray emitted from a high-pressure mercury lamp or a low-pressure mercury lamp. The irradiation energy is preferably 0.1 J/cm² or more and more preferably 0.5 J/cm² or more. The polymerizable compound is subject to inhibition of polymerization attributed to oxygen in the air, and thus the concentration of oxygen or the oxygen partial pressure during polymerization is preferably set to be low. In the case of decreasing the concentration of oxygen during polymerization using a nitrogen substitution method, the concentration of oxygen is preferably 2% or less and more preferably 0.5% or less. In the case of decreasing the oxygen partial pressure during polymerization using a pressure reduction method, the total pressure is preferably 1,000 Pa or lower and more preferably 100 Pa or lower. In addition, it is particularly preferable to carry out ultraviolet polymerization by radiating energy of 0.5 J/cm² or more under a pressure reduction condition of 100 Pa or lower.

The polymerization ratio of the polymerizable compound in the cured polymerizable composition is preferably 20% or more, more preferably 30% or more, and particularly preferably 50% or more. The polymerization ratio mentioned herein refers to a ratio of reacted polymerizable groups to all of polymerizable groups (for example, an acryloyl group and a methacryloyl group) in a monomer mixture. The amount of the polymerization ratio can be measured using an infrared absorption method.

The organic layer is preferably flat and has a high film hardness. Regarding the flatness of the organic layer, the 1 μm×1 μm average roughness (Ra value) is preferably less than 3 nm and more preferably less than 1 nm.

On the surface of the organic layer, the absence of a foreign substance such as a particle and a protrusion is demanded. Therefore, the organic layer is preferably formed in a cleanroom. Regarding the degree of cleanliness, the class regulated in Federal Standard Fed. Std. 209D is preferably 10,000 or less and more preferably 1,000 or less.

The hardness of the organic layer is preferably high. It is known that, in a case where the hardness of the organic layer is high, the inorganic layer is formed flat, and, consequently, the barrier property improves. The hardness of the organic layer can be expressed using microhardness based on a nanoindentation method. The microhardness of the organic layer is preferably 100 N/mm or higher and more preferably 150 N/mm or higher.

The thickness of the organic layer is not particularly limited, but is preferably 50 nm to 5,000 nm and more preferably 100 nm to 3,500 nm from the viewpoint of brittleness and light transmittance.

(Lamination of Organic Layer and Inorganic Layer)

The organic layers and the inorganic layers can be laminated by repeatedly forming the organic layers and the inorganic layers sequentially according to the layer configuration.

(Disposition Location of Barrier Layer)

In the case of being provided on a cover layer-side surface of the substrate, the barrier layer is capable of suppressing moisture reaching the display portion. Therefore, the barrier layer is preferably provided on the cover layer-side surface of the substrate. The barrier layers may be provided on both surfaces (the front surface and the rear surface) of the substrate.

In addition to being provided on the substrate, the barrier layer may also be provided on the first detection electrodes or the second detection electrodes so as to cover the conductive wires. In such a case, it is possible to suppress moisture reaching the display portion and suppress moisture reaching the conductive wires, and it is also possible to prevent the corrosion of the conductive wires. Even in the case of providing the barrier layer on the detection electrodes, the barrier layer needs to be provided on the detection electrodes disposed on the cover layer side of the substrate.

In the case of providing the barrier layer on the detection electrodes, there is a possibility that the barrier layer may be worn and damaged during the manufacturing process of the touch sensor portion, and thus it is preferable to separately provide a protective film that protects the surface of the barrier layer. As the protective film, an acrylic resin, a urethane resin, polycarbonate, or the like is used. Among these, polycarbonate is preferred as the protective film.

In the case of providing the barrier layers on both surfaces of the substrate or on both surface sides of the substrate, the substrate is configured to be covered by the barrier layers, and thus it is preferable to form a state in which moisture is sufficiently removed from the first detection electrodes, the second detection electrodes, and the substrate and then provide the barrier layers. Specifically, it is preferable to carry out a dehydration step on the substrate on which the first detection electrodes and the second detection electrodes are formed before the provision of the barrier layer. Once the barrier layer is provided, it is difficult to remove moisture, and thus the substrate is preferably a substrate that does not easily absorb moisture, and, for example, COP and COC are preferred.

The present invention is basically configured as described above. Hitherto, the composite member and the device of the embodiment of the present invention have been described in detail, but the present invention is not limited to the above-described embodiments, and the embodiments may be improved or modified in a variety of manners within the scope of the gist of the present invention.

### EXAMPLES

Hereinafter, characteristics of the present invention will be more specifically described using examples. Materials, reagents, amounts used, amounts of substances, proportions, processing contents, processing orders, and the like described in the following examples can be appropriately modified within the scope of the gist of the present invention. Therefore, the scope of the present invention is not interpreted to be limited by specific examples described below.

### First Example

In a first example, composite members of Examples 1 to 12, Comparative Example 1, and Comparative Example 2 were produced, and the degrees of an increase in the resistance of conductive layers by bending were investigated. Hereinafter, a resistance increase test will be described.

(Resistance Increase Test)

For the obtained composite members, the resistances of the respective conductive layers formed on both surfaces were measured before and after bending, and increases in the resistances of the conductive layers before and after bending were investigated. In Table 1 and Table 2, an inward fold side is the upper side of the columns of Table 1 and Table 2 and refers to a conductive layer close to a cover layer. In addition, an outward fold side refers to a conductive layer on a side opposite to the inward fold side and is the lower side of the columns of Table 1 and Table 2.

As the resistances, resistance values between wires were measured using a digital multimeter.

Regarding bending, the obtained composite member was treated for 20 minutes using an autoclave under conditions of a temperature of 40° C. and a pressure of 0.5 MPa. Next, the treated composite member was bent 100.000 times at a folding radius of 2 mm using a folding tester (Tension-Free U-shape folding tester (DLDMLH-FS) (manufactured by Yuasa System Co., Ltd.)).

In a bending test, a bending direction M was set so that a surface of the cover layer became inside in the case of bending the composite member.

For the composite member that had been subjected to 100,000 times of the bending test, an increase in resistance was obtained by measuring the resistances. A degree of an increase in resistance is represented by “A (delta)”. The increase in resistance was evaluated using the following evaluation standards. The evaluation results are shown in Table 1 and Table 2.

Evaluation Standards of Increase in Resistance

“A”: The resistance seldom changes, Δ<300Ω.

“B”: The resistance changes to an intermediate extent, 300 Ω≤Δ≤1,000Ω.

“C”: The resistance changes to an intermediate extent, 1,000Ω<Δ, the conductive layer does not break.

“D”: The conductive layer breaks.

The breakage of the conductive layer that corresponds to “D” as the evaluation refers to a resistance value of 50 MΩ or higher or above the measuring range of a device. A specific physical state of the breakage of the conductive layer refers to a state in which, for example, wires fracture in the middle and are not physically connected with each other.

Hereinafter, a method for producing a transparent conductive film configuring the composite member will be described.

<Method for Producing a Transparent Conductive Film>

(Preparation of Silver Halide Emulsion)

90% of the following second liquid and 90% of the following third liquid were added at the same time to the following first liquid having a temperature of 38° C. and a potential of hydrogen (pH) maintained at 4.5 for 20 minutes under stirring, thereby forming 0.16 μm nuclear particles. Subsequently, the following fourth liquid and the following fifth liquid were added thereto for eight minutes, and, furthermore, the remaining 10% of the following second liquid and the remaining 10% of the following third liquid were added thereto for two minutes, thereby causing the nuclear particles to grow up to 0.21 μm. Furthermore, 0.15 g of potassium iodide was added thereto, and the nuclear particles were aged for five minutes, thereby ending the formation of particles.

First Liquid:

Water: 750 mL

Gelatin: 9 g

Sodium chloride: 3 g

1,3-Dimethylimidazolidine-2-thione: 20 mg

Benzenethiosulfonic acid sodium salt: 10 mg

Citric acid: 0.7 g

Second Liquid:

Water: 300 mL

Silver nitrate: 150 g

Third Liquid:

Water: 300 mL

Sodium chloride: 38 g

Potassium bromide: 32 g

Potassium hexachloroiridate (III)

(20% aqueous solution of 0.005% KCl): 8 mL

Ammonium hexachlororhodate

(20% aqueous solution of 0.001% NaCl): 10 mL

Fourth Liquid:

Water: 100 mL

Silver nitrate: 50 g

Fifth Liquid:

Water: 100 mL

Sodium chloride: 13 g

Potassium bromide: 11 g

Yellow prussiate of potash: 5 mg

After that, the nuclear particles were washed with water according to an ordinary method using a flocculation method. Specifically, the temperature was lowered to 35° C., and the pH was lowered using sulfuric acid until silver halide sedimented (the pH was in a range of 3.6±0.2). Next, approximately 3 L of a supernatant liquid was removed (first water washing). Furthermore, 3 liters of distilled water was added thereto, and then sulfuric acid was added thereto until silver halide sedimented. Again, 3 L of the supernatant liquid was removed (second water washing). The same operation as the second water washing was further repeated once (third water washing), and a water washing and desalination step was ended. The water-washed and desalinated emulsion was adjusted to a pH of 6.4 and a pAg of 7.5, 3.9 g of gelatin, 10 mg of benzenethiosulfonic acid sodium salt, 3 mg of benzenethiosulfinic acid sodium salt, 15 mg of sodium thiosulfate, and 10 mg of a metal chloride were added thereto, chemical sensitization was carried out so as to obtain the optimal sensitivity at 55° C., and 100 mg of 1,3,3a,7-tetraazaindene as a stabilizer and 100 mg of PROXEL (trade name, manufactured by ICI Co., Ltd.) as a preservative were added thereto. The finally obtained emulsion was a silver iodochlorobromide cubic particle emulsion which included 0.08% by mol of silver iodide and had a ratio of silver chlorobromide of 70% by mol of silver chloride and 30% by mol of silver bromide, an average particle diameter of 0.22 μm, and a coefficient of variation of 9%.

(Preparation of Composition for Forming Photosensitive Layer)

1.2×10⁻⁴ mol/mol Ag of 1,3,3a,7-tetraazaindene, 1.2×10⁻² mol/mol Ag of hydroquinone, 3.0×10⁴ mol/mol Ag of citric acid, 0.90 g/mol Ag of 2,4-dichloro-6-hydroxy-1,3,5-triazine sodium salt, and a small amount of a curing agent were added to the above-described emulsion, and the pH of a coating fluid was adjusted to 5.6 using citric acid.

To the gelatin contained in the coating fluid, a polymer represented by (P-1) and a polymer latex containing a dispersant consisting of a dialkylphenyl PEO sulfuric acid ester (the mass ratio of the dispersant to the polymer was 2.0/100=0.02) were added so that the mass ratio of the polymer to gelatin reached 0.5/1.

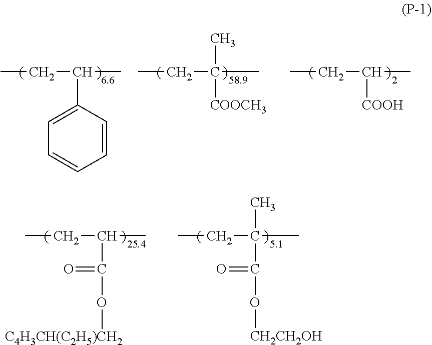

Furthermore, EPOXY RESIN DY022 (trade name: manufactured by Nagase ChemteX Corporation) was added thereto as a crosslinking agent. The amount of the crosslinking agent added was adjusted so that the amount of the crosslinking agent in a photosensitive layer described below reached 0.09 g/m²

A composition for forming a photosensitive layer was prepared as described above.

The above-described polymer represented by (P-1) was synthesized with reference to JP3305459B and JP3754745B.

(Photosensitive Layer-Forming Step)

A 40 μm-thick polyethylene terephthalate (PET) film was prepared as a substrate. The above-described polymer latex was applied onto both surfaces of the substrate, thereby providing 0.05 μm-thick undercoat layers.

Next, antihalation layers consisting of a mixture of the above-described polymer latex, gelatin, and a dye that had an optical density of approximately 1.0 and was decolorizable by an alkali of a developer were provided on the undercoat layers. The mixed mass ratio (polymer/gelatin) of the polymer to gelatin was 2/1, and the content of the polymer was 0.65 g/m².

The above-described composition for forming a photosensitive layer was applied onto the antihalation layers, furthermore, a composition obtained by mixing the above-described polymer latex, gelatin, EPOCROS K-2020E (trade name: manufactured by Nippon Shokubai Co., Ltd., oxazoline-based crosslinking reactive polymer latex (crosslinking group: an oxazoline group)), and SNOWTEX C (registered trademark, trade name: manufactured by Nissan Chemical Corporation, colloidal silica) in a solid content mass ratio (the polymer/gelatin/EPOCROS K-2020E/SNOWTEX C (registered trademark)) of 1/1/0.3/2 was applied thereto so that the amount of gelatin reached 0.08 g/m², thereby obtaining a support base body having photosensitive layers formed on both surfaces. The support base body having photosensitive layers formed on both surfaces is regarded as a film A. In the formed photosensitive layer, the amount of silver was 6.2 g/m², and the amount of gelatin was 1.0 g/m².

(Exposure and Development Step)

As exposure masks for forming the conductive wires 50, exposure masks having a mesh pattern as shown in FIG. 10 were respectively prepared. The mesh-pattern exposure masks were disposed on both surfaces of the film A, and exposure using parallel light rays emitted from a high-pressure mercury lamp as a light source was repeatedly carried out at predetermined pattern intervals. As the mesh pattern, a mesh pattern in which the length of one side of a grid was set to 150 μm and a wire width was set to 4 μm was used.

After exposure, the film was developed using the following developer, and a development treatment was carried out using a fixer (trade name: N3X-R for CN16X, manufactured by Fujifilm Corporation). Furthermore, the film was rinsed with pure water and dried, thereby obtaining a support base body having pattern portions consisting of silver fine wires and gelatin layers formed on both surfaces. The gelatin layers were formed between the silver fine wires. The obtained film is regarded as a film B.

(Composition of Developer)

1 Liter (L) of the developer includes the following compounds.

Hydroquinone: 0.037 mol/L

N-methylaminophenol: 0.016 mol/L

Sodium metaborate: 0.140 mol/L

Sodium hydroxide: 0.360 mol/L

Sodium bromide: 0.031 mol/L

Potassium metabisulfite: 0.187 mol/L

(Gelatin Degradation Treatment)

The film B was immersed in an aqueous solution of a protein degradation enzyme (BIOPLASE Al-15FG manufactured by Nagase ChemteX Corporation) (the concentration of the protein degradation enzyme: 0.5% by mass, the liquid temperature: 40° C.) for 120 seconds. The film B was removed from the aqueous solution, immersed in warm water (liquid temperature: 50° C.) for 120 seconds, and washed. A film after a gelatin degradation treatment is regarded as a film C.

(Resistance Decrease Treatment)

A calender treatment was carried out on the film C using a calender device consisting of a metal roller at a pressure of 30 kN. At this time, two polyethylene terephthalate (PET) films having a rough surface shape having a wire roughness Ra of 0.2 μm and Sm of 1.9 μm (measured (JIS-B-0601-1994) using a shape analysis laser microscope VK-X110 manufactured by Keyence Corporation) were transported together so that the rough surfaces faced a front surface and a rear surface of the film C, thereby transferring and forming the rough surface shape to the front surface and the rear surface of the film C.

After the calender treatment, the film was passed through an overheated steam tank (temperature: 150° C.) for 120 seconds, thereby carrying out a heating treatment. A film after the heating treatment is a transparent conductive film.

Hereinafter, Examples 1 to 12, Comparative Example 1, and Comparative Example 2 of the first example will be described.

### Example 1

In Example 1, a cover layer (40 μm-thick polyethylene terephthalate (PET) film), a pressure-sensitive adhesive layer (MO-3015C (trade name) manufactured by Lintec Corporation), a A/4 layer, a polarizer layer, a pressure-sensitive adhesive layer (MO-3015G (trade name) manufactured by Lintec Corporation), and a transparent conductive film configuring a touch sensor portion were attached and laminated together. A 10 μm-thick polyethylene terephthalate (PET) film was provided below the touch sensor portion through a 1 μm-thick adhesive layer. A pressure-sensitive adhesive layer (MO-3015C (trade name) manufactured by Lintec Corporation), a polyimide film (film thickness: 30 μm), a pressure-sensitive adhesive layer (MO-3015C (trade name) manufactured by Lintec Corporation), and a polyimide film (film thickness: 125 μm) were sequentially attached and laminated together below the 10 μm-thick polyethylene terephthalate (PET) film, thereby forming a composite member. The thicknesses of the pressure-sensitive adhesive layers were all set to 25 μm. The above-described 1 μm-thick adhesive layer was formed using an acrylic adhesive. The above-described 1 μm-thick adhesive layer corresponds to the member having a higher modulus of elasticity than the pressure-sensitive adhesive layer.

In Table 1 and Table 2, numerical values in parentheses indicate film thicknesses. In addition, in Table 1 and Table 2, “PET” indicates the polyethylene terephthalate film, and “PI” indicates the polyimide film.

### Example 2

Example 2 was different from Example 1 in terms of the fact that a 0.8 μm-thick protective layer was provided instead of the 1 μm-thick adhesive layer and the 10 μm-thick PET film, and, except for the above-described fact, the same configuration as in Example 1 was provided.

The 0.8 μm-thick protective layer was produced by applying XSR-5N manufactured by Arakawa Chemical Industries, Ltd. by means of screen printing and ultraviolet (UV)-exposing and curing XSR-5N. In Example 2 to Example 4 and Examples 6 to 12, all protective layers correspond to the member having a higher modulus of elasticity than the pressure-sensitive adhesive layer.

### Example 3

Example 3 was different from Example 1 in terms of the fact that a 5 μm-thick protective layer was provided instead of the 1 μm-thick adhesive layer and the 10 μm-thick PET film, and, except for the above-described fact, the same configuration as in Example 1 was provided.

The 5 μm-thick protective layer was produced by applying XSR-5N manufactured by Arakawa Chemical Industries, Ltd. by means of screen printing and UV-exposing and curing XSR-5N.

### Example 4

Example 4 was different from Example 1 in terms of the fact that a 15 μm-thick protective layer was provided instead of the 1 μm-thick adhesive layer and the 10 μm-thick PET film, and, except for the above-described fact, the same configuration as in Example 1 was provided.

The 15 μm-thick protective layer was produced by applying XSR-5N manufactured by Arakawa Chemical Industries, Ltd. by means of screen printing and UV-exposing and curing XSR-5N.

### Example 5

Example 5 was different from Example 1 in terms of the fact that a 15 μm-thick protective layer was provided instead of the 1 μm-thick adhesive layer and the 10 μm-thick PET film and a 15 μm-thick protective layer was provided between the pressure-sensitive adhesive layer (MO-3015C (trade name) manufactured by Lintec Corporation) and the transparent conductive film, and, except for the above-described fact, the same configuration as in Example 1 was provided.

The two 15 μm-thick protective layer were both produced by applying XSR-5N manufactured by Arakawa Chemical Industries. Ltd. by means of screen printing and UV-exposing and curing XSR-5N. In Example 5, the protective layer on the outward fold side corresponds to the member having a higher modulus of elasticity than the pressure-sensitive adhesive layer.

### Example 6

Example 6 was different from Example 1 in terms of the fact that a 40 μm-thick protective layer was provided instead of the 1 μm-thick adhesive layer and the 10 μm-thick PET film, and, except for the above-described fact, the same configuration as in Example 1 was provided.

The 40 μm-thick protective layer was produced by repeating a step of applying XSR-5N manufactured by Arakawa Chemical Industries, Ltd. by means of screen printing and UV-exposing and curing XSR-5N three times.

### Example 7

Example 7 was different from Example 1 in terms of the fact that a 100 μm-thick protective layer was provided instead of the 1 μm-thick adhesive layer and the 10 μm-thick PET film, and, except for the above-described fact, the same configuration as in Example 1 was provided.

The 100 μm-thick protective layer was produced by repeating a step of applying XSR-5N manufactured by Arakawa Chemical Industries, Ltd. by means of screen printing and UV-exposing and curing XSR-5N six times.

### Example 8

Example 8 was different from Example 4 in terms of the fact that the configuration of the touch sensor portion was different, and, except for the above-described fact, the same configuration as in Example 4 was provided.

In Example 8, a barrier layer was provided on a cover layer-side surface of a substrate of the touch sensor portion. The barrier layer was produced as described below.

<Barrier Layer>

A composition was prepared by mixing trimethylolpropane triacrylate (TMPTA; manufactured by Daicel Corporation), a silane coupling agent (KBM-5103, manufactured by Shin-Etsu Chemical Co., Ltd.), and a polymerizable acidic compound (KARAMER PM-21, manufactured by Nippon Kayaku Co., Ltd.) in a mass ratio of 14.1:3.5:1.

18.6 g of this composition, 1.4 g of an ultraviolet polymerization initiator (manufactured by Lamberti S.p.A, ESACURE KTO 46), and 180 g of 2-butanone were mixed together, thereby preparing a composition for forming an organic layer.

The composition for forming an organic layer was applied to a cover layer-side surface of a substrate of the transparent conductive film. The composition for forming an organic layer was applied using a wire bar so that the thickness of a coated film reached 20 μm. The applied composition for forming an organic layer was dried by being left to stand at room temperature.

Next, the composition for forming an organic layer was cured by radiating ultraviolet rays (at a cumulative irradiance of approximately 1 J/cm²) from a high-pressure mercury lamp in a chamber in which the concentration of oxygen was set to 0.1% using a nitrogen substitution method, thereby forming an organic layer having a thickness of 4,000 nm±50 nm on the surface of the substrate.

A 30 nm-thick silicon nitride film was formed as an inorganic layer on a surface of the formed organic layer.

The inorganic layer (silicon nitride film) was formed using an ordinary capacitively coupled plasma (CCP)-type chemical vapor deposition (CVD) device. As raw material gases, silane gas (flow rate: 160 standard cubic centimeters per minute (sccm)), ammonia gas (flow rate: 370 sccm), hydrogen gas (flow rate: 590 sccm), and nitrogen gas (flow rate: 240 sccm) were used. A pressure for film formation was set to 40 Pa. As a power supply, a high-frequency power supply having a frequency of 13.56 MHz was used, and a plasma excitation power was set to 2.5 kW.

### Example 9

Example 9 was different from Example 8 in terms of the fact that the configuration of the touch sensor portion was different, and, except for the above-described fact, the same configuration as in Example 8 was provided.

In Example 9, barrier layers were provided on both surfaces of the substrate of the touch sensor portion. The barrier layer in Example 9 had the same configuration as the barrier layer in Example 8 and was produced using the same production method as for the barrier layer in Example 8 except for the fact that the barrier layers were provided on both surfaces of the substrate.

### Example 10

Example 10 was different from Example 8 in terms of the fact that the configuration of the touch sensor portion was different, and, except for the above-described fact, the same configuration as in Example 8 was provided.

In Example 10, barrier layers were provided on conductive wires respectively provided on both surfaces of the substrate of the touch sensor portion. The barrier layer in Example 10 had the same configuration as the barrier layer in Example 8 and was produced using the same production method as for the barrier layer in Example 8 except for the fact that the barrier layers were provided on the conductive wires respectively provided on both surfaces of the substrate.

### Example 11

Example 11 was different from Example 8 in terms of the fact that the configuration of the touch sensor portion was different, and, except for the above-described fact, the same configuration as in Example 8 was provided.

In Example 11, only 30 nm-thick silicon nitride films were provided as the barrier layers on the conductive wires respectively provided on both surfaces of the substrate of the touch sensor portion. The silicon nitride film in Example 11 was produced using the same production method as in Example 8.

### Example 12

Example 12 was different from Example 8 in terms of the fact that the configuration of the touch sensor portion was different, and, except for the above-described fact, the same configuration as in Example 8 was provided.

In Example 12, a barrier layer was provided on the conductive wires on the cover layer-side surface of the substrate of the touch sensor portion. The barrier layer in Example 12 had the same configuration as the barrier layer in Example 8 and was produced using the same production method as for the barrier layer in Example 8 except for the fact that the barrier layer was provided on the conductive wires on the cover layer-side surface.

### Comparative Example 1

Comparative Example 1 was different from Example 1 in terms of the fact that the 1 μm-thick adhesive layer and the 10 μm-thick PET film were not provided, that is, the member having a higher modulus of elasticity than the pressure-sensitive adhesive layer was not provided, and, except for the above-described fact, the same configuration as in Example 1 was provided.

### Comparative Example 2

Comparative Example 2 was different from Example 1 in terms of the fact that the 1 μm-thick adhesive layer and the 10 μm-thick PET film were not provided and the substrate of the touch sensor portion was a gas barrier film, and, except for the above-described fact, the same configuration as in Example 1 was provided. In Comparative Example 2, similar to Comparative Example 1, the member having a higher modulus of elasticity than the pressure-sensitive adhesive layer was not provided.

TABLE 1

| Layer configuration | Example 1 | Example 2 | Example 3 | Example 4 |
|---|---|---|---|---|
| Inward fold side | PET (40 μm) | PET (40 μm) | PET (40 μm) | PET (40 μm) |
| | Pressure-sensitive | Pressure-sensitive | Pressure-sensitive | Pressure-sensitive |
| | adhesive layer | adhesive layer | adhesive layer | adhesive layer |
| | (λ/4 layer)/ | (λ/4 layer)/ | (λ/4 layer)/ | (λ/4 layer)/ |
| | (polarizer layer) | (polarizer layer) | (polarizer layer) | (polarizer layer) |
| | Pressure-sensitive | Pressure-sensitive | Pressure-sensitive | Pressure-sensitive |
| | adhesive layer | adhesive layer | adhesive layer | adhesive layer |
| | Touch sensor portion | Touch sensor portion | Touch sensor portion | Touch sensor portion |
| | Adhesive layer (1 μm) | Protective layer (0.8 μm) | Protective layer (5 μm) | Protective layer (15 μm) |
| | PET (10 μm) | Pressure-sensitive | Pressure-sensitive | Pressure-sensitive |
| | | adhesive layer | adhesive layer | adhesive layer |
| | Pressure-sensitive | PI (30 μm) | PI (30 μm) | PI (30 μm) |
| | adhesive layer | | | |
| | PI (30 μm) | Pressure-sensitive | Pressure-sensitive | Pressure-sensitive |
| | | adhesive layer | adhesive layer | asthesive layer |
| | Pressure-sensitive | PI (125 μm) | PI (125 μm) | PI (125 μm) |
| | adhesive layer | | | |
| Outward fold side | PI (125 μm) | — | — | — |
| Increase in resistance | B | B | A | B |
| (outward fold side) | | | | |
| Increase in resistance | A | A | A | A |
| (inward fold side) | | | | |
| Layer configuration | Example 5 | Example 6 | Example 7 | Comparative Example 1 |
| Inward fold side | PET (40 μm) | PET (40 μm) | PET (40 μm) | PET (40 μm) |
| | Pressure-sensitive | Pressure-sensitive | Pressure-sensitive | Pressure-sensitive |
| | adhesive layer | adhesive layer | adhesive layer | adhesive layer |
| | (λ/4 layer)/ | (λ/4 layer)/ | (λ/4 layer)/ | (λ/4 layer)/ |
| | (polarizer layer) | (polarizer layer) | (polarizer layer) | (polarizer layer) |
| | Pressure-sensitive | Pressure-sensitive | Pressure-sensitive | Pressure-sensitive |
| | adhesive layer | adhesive layer | adhesive layer | adhesive layer |
| | Protective layer (15 μm) | Touch sensor portion | Touch sensor portion | Touch sensor portion |
| | Touch sensor portion | Protective layer (40 μm) | Protective layer (100 | Pressure-sensitive |
| | | | μm) | adhesive layer |
| | Protective layer (15 μm) | Pressure-sensitive | Pressure-sensitive | PI(30 μm) |
| | | adhesive layer | adhesive layer | |
| | Pressure-sensitive | PI (30 μm) | PI (30 μm) | Pressure-sensitive |
| | adhesive layer | | | adhesive layer |
| | PI (30 μm) | Pressure-sensitive | Pressure-sensitive | PI (125 μm) |
| | | adhesive layer | adhesive layer | |
| | Pressure-sensitive | PI (125 μm) | PI (125 μm) | — |
| | adhesive layer | | | |
| Outward fold side | PI (125 μm) | — | — | — |
| Increase in resistance | B | B | C | D |
| (outward fold side) | | | | |
| Increase in resistance | B | A | A | A |
| (inward fold side) | | | | |

TABLE 2

| Layer configuration | Example 8 | Example 9 | Example 10 |
|---|---|---|---|
| Inward fold side | PET (40 μm) | PET (40 μm) | PET (40 μm) |
| | Pressure-sensitive | Pressure-sensitive | Pressure-sensitive |
| | adhesive layer | adhesive layer | adhesive layer |
| | (μ/4 layer)/ | (μ/4 layer)/ | (λ/4 layer)/ |
| | (polarizer layer) | (polarizer layer) | (polarizer layer) |
| | Pressure-sensitive | Pressure-sensitive | Pressure-sensitive |
| | adhesive layer | adhesive layer | adhesive layer |
| | Touch sensor portion | Touch sensor portion | Touch sensor portion |
| | Protective layer (15 μm) | Protective layer (15 μm) | Protective layer (15 μm) |
| | Pressure-sensitive | Pressure-sensitive | Pressure-sensitive |
| | adhesive layer | adhesive layer | adhesive layer |
| | PI (30 μm) | PI (30 μm) | PI (30 μm) |
| | Pressure-sensitive | Pressure-sensitive | Pressure-sensitive |
| | adhesive layer | adhesive layer | adhesive layer |
| | PI (125 μm) | PI (125 μm) | PI (125 μm) |
| Outward fold side | — | — | — |
| Increase in resistance | B | B | B |
| (outward fold side) | | | |
| Increase in resistance | A | A | A |
| (inward fold side) | | | |
| Layer configuration | Example 11 | Example 12 | Comparative Example 2 |
| Inward fold side | PET (40 μm) | PET (40 μm) | PET (40 μm) |
| | Pressure-sensitive | Pressure-sensitive | Pressure-sensitive |
| | adhesive layer | adhesive layer | adhesive layer |
| | (λ/4 layer)/ | (λ/4 layer)/ | (λ/4 layer)/ |
| | (polarizer layer) | (polarizer layer) | (polarizer layer) |
| | Pressure-sensitive | Pressure-sensitive | Pressure-sensitive |
| | adhesive layer | adhesive layer | adhesive layer |
| | Touch sensor portion | Touch sensor portion | Touch sensor portion |
| | Protective layer (15 μm) | Protective layer (15 μm) | Pressure-sensitive |
| | | | adhesive layer |
| | Pressure-sensitive | Pressure-sensitive | PI (30 μm) |
| | adhesive layer | adhesive layer | |
| | PI (30 μm) | PI (30 μm) | Pressure-sensitive |
| | | | adhesive layer (15 μm) |
| | Pressure-sensitive | Pressure-sensitive | PI (125 μm) |
| | adhesive layer | adhesive layer | |
| | PI (125 μm) | PI (125 μm) | — |
| Outward fold side | — | — | — |
| Increase in resistance | B | B | D |
| (outward fold side) | | | |
| Increase in resistance | A | A | A |
| (inward fold side) | | | |

As shown in Table 1 and Table 2, in Examples 1 to 12, the degrees of an increase in resistance on the outward fold side were smaller than those in Comparative Example 1 and Comparative Example 2. In addition, the degree of an increase in resistance was small in a case where the protective layer was thin. As such, the composite member of the embodiment of the present invention controls stress being exerted on the conductive layers to decrease a tensile stress and suppresses an increase in the resistance of the conductive layer on the outward fold side.

### Second Example

Hereinafter, a second example will be described.

In the second example, for Examples 20 to 31 and Comparative Example 10 described below, increases in the resistance of the conductive layer and peeling were evaluated. Hereinafter, the increase in resistance and peeling will be described.

The increase in the resistance of the conductive layer, including evaluation thereof, is the same as the increase in resistance in Example 1 and thus will not be described in detail. The increase in resistance was evaluated only on the outward fold side.

(Peeling)

Regarding peeling, individual composite members of Examples 20 to 31 and Comparative Example 10 were treated for 20 minutes using an autoclave under conditions of a temperature of 40° C. and a pressure of 0.5 MPa. Next, the treated individual composite members were bent 100,000 times at a folding radius of 2 mm using a folding tester (Tension-Free U-shape folding tester (DLDMLH-FS) (manufactured by Yuasa System Co., Ltd.)). The states of the individual composite members that had been folded 100,000 times were visually observed, and peeling was evaluated using the following evaluation standards. The evaluation results are shown in Table 3 and Table 4.

Evaluation Standards of Peeling

“A”: No peeling occurs.

“B”: Slight peeling occurs.

“C”: Peeling occurs.

Examples 20 to 31 and Comparative Example 10 of the second example will be described.

### Example 20

In Example 20, a cover layer (40 μm-thick polyethylene terephthalate (PET) film), a pressure-sensitive adhesive layer (MO-3015C (trade name) manufactured by Lintec Corporation), a λ/4 layer, a polarizer layer, a pressure-sensitive adhesive layer (MO-3015G (trade name) manufactured by Lintec Corporation), and a touch sensor portion were attached and laminated together. A 10 μm-thick polyethylene terephthalate (PET) film was provided below the touch sensor portion through a 1 μm-thick adhesive layer. A pressure-sensitive adhesive layer (MO-3015C (trade name) manufactured by Lintec Corporation), a polyimide film (film thickness: 30 μm), a pressure-sensitive adhesive layer (MO-3015C (trade name) manufactured by Lintec Corporation), and a polyimide film (film thickness: 125 μm) were sequentially attached and laminated together below the 10 μm-thick polyethylene terephthalate (PET) film, thereby forming a composite member. The thicknesses of the pressure-sensitive adhesive layers were all set to 25 μm. The above-described 1 μm-thick adhesive layer was formed using an acrylic adhesive. The above-described 1 μm-thick adhesive layer corresponds to the member having a higher modulus of elasticity than the pressure-sensitive adhesive layer.

In Table 3 and Table 4, numerical values in parentheses indicate film thicknesses. In addition, in Table 3 and Table 4, “PET” indicates the polyethylene terephthalate film, and “PI” indicates the polyimide film.

The touch sensor portion has a configuration of a bilayer electrode on a single surface. That is, two conductive layers are both disposed on the outward fold side in the configuration. The touch sensor portion having two conductive layers on a single surface was produced as described below.

For the touch sensor portion, first, XSR-5N manufactured by Arakawa Chemical Industries, Ltd. was applied onto a 40 μm-thick cycloolefin polymer (COP) base material in a thickness of 2 μm and cured by ultraviolet (UV) exposure, thereby forming a first applied film. A first laminate film in which a 0.05 μm-thick Mo film, a 0.3 μm-thick Al film, and a 0.05 μm-thick Mo film were sequentially laminated on the first applied film was formed using a sputtering method. The first laminate film was patterned into a pattern of a conductive layer using a photolithography method, thereby forming a first tier of a conductive layer.

Furthermore, XSR-5N manufactured by Arakawa Chemical Industries, Ltd. was applied to cover the first tier of the conductive layer in a thickness of 3 μm and cured by ultraviolet (UV) exposure, thereby forming a second applied film. A second laminate film in which a 0.05 μm-thick Mo film, a 0.3 μm-thick Al film, and a 0.05 μm-thick Mo film were sequentially laminated on the second applied film was formed using a sputtering method. The second laminate film was patterned into a pattern of a conductive layer using a photolithography method, thereby forming a second tier of a conductive layer. After that, an opening portion was formed in the first applied film using a photolithography method as a portion in which the first tier of the conductive layer and an external wire were electrically connected to each other.

Regarding the touch sensor portions, in Table 3 and Table 4, a touch sensor portion in which the two conductive layers were both disposed on the outward fold side is expressed as “bilayer electrode on single surface (outward fold side electrode)”, and a touch sensor portion in which the two conductive layers were both disposed on the inward fold side is expressed as “bilayer electrode on single surface (inward fold side electrode)”.

### Example 21

Example 21 was different from Example 20 in terms of the fact that a 2 μm-thick protective layer was provided instead of the 1 μm-thick adhesive layer and the 10 μm-thick PET film, and, except for the above-described fact, the same configuration as in Example 20 was provided.

The 2 μm-thick protective layer was produced by applying XSR-5N manufactured by Arakawa Chemical Industries, Ltd. by means of screen printing and ultraviolet (UV)-exposing and curing XSR-5N. In Example 21 to Example 23, all protective layers correspond to the member having a higher modulus of elasticity than the pressure-sensitive adhesive layer.

### Example 22

Example 22 was different from Example 20 in terms of the fact that a 15 μm-thick protective layer was provided instead of the 1 μm-thick adhesive layer and the 10 μm-thick PET film, and, except for the above-described fact, the same configuration as in Example 20 was provided.

The 15 μm-thick protective layer was produced by applying XSR-5N manufactured by Arakawa Chemical Industries, Ltd. by means of screen printing and ultraviolet (UV)-exposing and curing XSR-5N.

### Example 23

Example 23 was different from Example 20 in terms of the fact that a 25 μm-thick protective layer was provided instead of the 1 μm-thick adhesive layer and the 10 μm-thick PET film, and, except for the above-described fact, the same configuration as in Example 20 was provided.

The 25 μm-thick protective layer was produced by applying XSR-5N manufactured by Arakawa Chemical Industries, Ltd. by means of screen printing and ultraviolet (UV)-exposing and curing XSR-5N.

### Example 24

Example 24 was different from Example 20 in terms of the fact that the 1 μm-thick adhesive layer and the 10 μm-thick PET film were not provided and the two conductive layers in the touch sensor portion were all disposed on the inward fold side in the configuration, and, except for the above-described fact, the same configuration as in Example 20 was provided.

In Example 24, the COP base material in the touch sensor portion corresponds to the member having a higher modulus of elasticity than the pressure-sensitive adhesive layer.

### Example 25

Example 25 was different from Example 20 in terms of the fact that the 1 μm-thick adhesive layer and the 10 μm-thick PET film were not provided, the two conductive layers in the touch sensor portion were all disposed on the inward fold side in the configuration, and a 15 μm-thick protective layer was provided on the inward fold side of the touch sensor portion, and, except for the above-described fact, the same configuration as in Example 20 was provided.

In Example 25, the COP base material in the touch sensor portion corresponds to the member having a higher modulus of elasticity than the pressure-sensitive adhesive layer.

### Example 26

Example 26 was different from Example 22 in terms of the fact that a barrier layer was provided on a cover layer-side surface of the COP base material of the touch sensor portion, and, except for the above-described fact, the same configuration as in Example 22 was provided. The barrier layer had the same configuration as the barrier layer in Example 8 of the first example and was produced using the same production method as for the barrier layer in Example 8.

### Example 27

Example 27 was different from Example 22 in terms of the fact that a barrier layer was provided on a protective layer-side conductive layer of the touch sensor portion, and, except for the above-described fact, the same configuration as in Example 22 was provided. The barrier layer had the same configuration as the barrier layer in Example 8 of the first example and was produced using the same production method as for the barrier layer in Example 8.

### Example 28

Example 28 was different from Example 22 in terms of the fact that barrier layers were provided on the cover layer-side surface of the COP base material of the touch sensor portion and the protective layer-side conductive layer, and, except for the above-described fact, the same configuration as in Example 22 was provided. The barrier layer had the same configuration as the barrier layer in Example 8 of the first example and was produced using the same production method as for the barrier layer in Example 8.

### Example 29

Example 29 was different from Example 24 in terms of the fact that a barrier layer was provided on a protective layer-side surface of the COP base material of the touch sensor portion, and, except for the above-described fact, the same configuration as in Example 24 was provided. The barrier layer had the same configuration as the barrier layer in Example 8 of the first example and was produced using the same production method as for the barrier layer in Example 8.

### Example 30

Example 30 was different from Example 24 in terms of the fact that a barrier layer was provided on a cover layer-side surface conductive layer of the touch sensor portion, and, except for the above-described fact, the same configuration as in Example 24 was provided. The barrier layer had the same configuration as the barrier layer in Example 8 of the first example and was produced using the same production method as for the barrier layer in Example 8.

### Example 31

Example 31 was different from Example 24 in terms of the fact that barrier layers were provided on the protective layer-side surface of the COP base material of the touch sensor portion and the cover layer-side conductive layer, and, except for the above-described fact, the same configuration as in Example 24 was provided. The barrier layer had the same configuration as the barrier layer in Example 8 of the first example and was produced using the same production method as for the barrier layer in Example 8.

### Comparative Example 10

Comparative Example 10 was different from Example 20 in terms of the fact that the 1 μm-thick adhesive layer and the 10 μm-thick PET film were not provided, that is, the member having a higher modulus of elasticity than the pressure-sensitive adhesive layer was not provided, and, except for the above-described fact, the same configuration as in Example 20 was provided.

TABLE 3

| Layer configuration | Example 20 | Example 21 | Example 22 |
|---|---|---|---|
| Inward fold side | PET (40 μm) | PET (40 μm) | PET (40 μm) |
| | Pressure-sensitive | Pressure-sensitive | Pressure-sensitive |
| | adhesive layer | adhesive layer | adhesive layer |
| | (λ/4 layer)/ | (λ/4 layer)/ | (λ/4 layer)/ |
| | (polarizer layer) | (polarizer layer) | (polarizer layer) |
| | Pressure-sensitive | Pressure-sensitive | Pressure-sensitive |
| | adhesive layer | adhesive layer | adhesive layer |
| | Touch sensor portion | Touch sensor portion | Touch sensor portion |
| | (bilayer electrode on | (bilayer electrode on | (bilayer electrode on |
| | single surface (outward | single surface (outward | single surface (outward |
| | fold side electrode)) | fold side electrode)) | fold side electrode)) |
| | Adhesive layer (1 μm) | Protective layer (2 μm) | Protective layer (15 μm) |
| | PET (10 μm) | — | — |
| | Pressure-sensitive | Pressure-sensitive | Pressure-sensitive |
| | adhesive layer | adhesive layer | adhesive layer |
| | PI (30 μm) | PI (30 μm) | PI (30 μm) |
| | Pressure-sensitive | Pressure-sensitive | Pressure-sensitive |
| | adhesive layer | adhesive layer | adhesive layer |
| Outward fold side | PI (125 μm) | PI (125 μm) | PI (125 μm) |
| Increase in resistance | C | A | B |
| (outward fold side) | | | |
| Peeling | C | A | A |
| Layer configuration | Example 23 | Example 24 | Example 25 |
| Inward fold side | PET (40 μm) | PET (40 μm) | PET (40 μm) |
| | Pressure-sensitive | Pressure-sensitive | Pressure-sensitive |
| | adhesive layer | adhesive layer | adhesive layer |
| | (λ/4 layer)/ | (λ/4 layer)/ | (λ/4 layer)/ |
| | (polarizer layer) | (polarizer layer) | (polarizer layer) |
| | Pressure-sensitive | Pressure-sensitive | Pressure-sensitive |
| | adhesive layer | adhesive layer | adhesive laver |
| | Touch sensor portion | Touch sensor portion | Protective layer (15 μm) |
| | (bilayer electrode on | (bilayer electrode on | |
| | single surface (outward | single surface (inward | |
| | fold side electrode)) | fold side electrode)) | |
| | Protective layer (25 μm) | — | Touch sensor portion |
| | | | (bilayer electrode on |
| | | | single surface (inward |
| | | | fold side electrode)) |
| | — | — | — |
| | Pressure-sensitive | Pressure-sensitive | Pressure-sensitive |
| | adhesive layer | adhesive layer | adhesive layer |
| | PI (30 μm) | PI (30 μm) | PI (30 μm) |
| | Pressure-sensitive | Pressure-sensitive | Pressure-sensitive |
| | adhesive layer | adhesive layer | adhesive layer |
| Outward fold side | PI (125 μm) | PI (125 μm) | PI (125 μm) |
| Increase in resistance | C | A | B |
| (outward fold side) | | | |
| Peeling | B | A | A |

TABLE 4

| Layer configuration | Example 26 | Example 27 | Example 28 | Example 29 |
|---|---|---|---|---|
| Inward fold side | PET (40 μm) | PET (40 μm) | PET (40 μm) | PET (40 μm) |
| | Pressure-sensitive | Pressure-sensitive | Pressure-sensitive | Pressure-sensitive |
| | adhesive layer | adhesive layer | adhesive layer | adhesive layer |
| | (λ/4 layer)/ | (λ/4 layer)/ | (λ/4 layer)/ | (λ/4 layer)/ |
| | (polarizer layer | (polarizer layer) | (polarizer layer) | (polarizer layer) |
| | Pressure-sensitive | Pressure-sensitive | Pressure-sensitive | Pressure-sensitive |
| | adhesive layer | adhesive layer | adhesive layer | adhesive layer |
| | Touch sensor portion | Touch sensor portion | Touch sensor portion | Touch sensor portion |
| | (bilayer electrode on | (bilayer electrode on | (bilayer electrode on | (bilayer electrode on |
| | single surface (outward | single surface (outward | single surface (outward | single surface (inward |
| | fold side electrode)) | fold side electrode)) | fold side electrode)) | fold side electrode)) |
| | Protective layer (15 μm) | Protective layer (15 μm) | Protective layer (15 μm) | — |
| | — | — | — | — |
| | Pressure-sensitive | Pressure-sensitive | Pressure-sensitive | Pressure-sensitive |
| | adhesive layer | adhesive layer | adhesive layer | adhesive layer |
| | PI (30 μm) | PI (30 μm) | PI (30 μm) | PI (30 μm) |
| | Pressure-sensitive | Pressure-sensitive | Pressure-sensitive | Pressure-sensitive |
| | adhesive layer | adhesive layer | adhesive layer | adhesive layer |
| Outward fold side | PI (125 μm) | PI (125 μm) | PI (125 μm) | PI (125 μm) |
| Increase in resistance | B | B | B | A |
| (outward fold side) | | | | |
| Peeling | A | A | A | A |

| Layer configuration | Example 30 | Example 31 | Comparative Example 10 |
|---|---|---|---|
| Inward fold side | PET (40 μm) | PET (40 μm) | PET (40 μm) |
| | Pressure-sensitive | Pressure-sensitive | Pressure-sensitive |
| | adhesive layer | adhesive layer | adhesive layer |
| | (μ/4 layer)/ | (λ/4 layer)/ | (λ/4 layer)/ |
| | (polarizer layer) | (polarizer layer) | (polarizer layer) |
| | Pressure-sensitive | Pressure-sensitive | Pressure-sensitive |
| | adhesive layer | adhesive layer | adhesive layer |
| | Touch sensor portion | Touch sensor portion | Touch sensor portion |
| | (bilayer electrode on | (bilayer electrode on | (bilayer electrode on |
| | single surface (inward | single surface (inward | single surface (outward |
| | fold side electrode)) | fold side electrode)) | fold side electode)) |
| | — | — | — |
| | — | — | — |
| | Pressure-sensitive | Pressure-sensitive | Pressure-sensitive |
| | adhesive layer | adhesive layer | adhesive layer |
| | PI (30 μm) | PI (30 μm) | PI (30 μm) |
| | Pressure-sensitive | Pressure-sensitive | Pressure-sensitive |
| | adhesive layer | adhesive layer | adhesive layer |
| Outward fold side | PI (125 μm) | PI (125 μm) | PI (125 μm) |
| Increase in resistance | A | A | D |
| (outward fold side) | | | |
| Peeling | A | A | B |

As shown in Table 3 and Table 4, in Examples 20 to 31, the degrees of an increase in resistance on the outward fold side were smaller than that in Comparative Example 10. In addition, in the configurations of Examples 21 to 23 in which the protective layer was provided, the degree of an increase in resistance was small in a case where the protective layer was thin, and favorable results were obtained regarding peeling. As such, the composite member of the embodiment of the present invention controls stress being exerted on the conductive layers to decrease a tensile stress and suppresses an increase in the resistance of the conductive layer on the outward fold side.

### EXPLANATION OF REFERENCES

10: member
10a, 11a, Ds: stress
11: member
12: laminate
20, 20a: display device
21: composite member
22: display portion
23, 25, 27: transparent layer
24, 26: plastic film
27: first pressure-sensitive adhesive layer
28: first protective layer
30, 30a, 30b, 30c: touch sensor portion
31: second protective layer
32: second pressure-sensitive adhesive layer
33: antireflection layer
34: transparent layer
36: cover layer
36a: front surface
37: controller
40: insulating substrate
40a, 48a: front surface
40b, 48b: rear surface
41: conductive layer body
42: first detection electrode
43: first peripheral wire
44: second detection electrode
45: second peripheral wire
47: detection region
48: insulating layer
50: conductive wire
60, 62, 64: display device
60a: central portion
60b, 62a: first side portion
60c, 62b: second side portion
60d, 62c, 64a: display region
60e, 62d: end portion
M: bending direction
X: second direction
Y: first direction
t, ts: thickness
td: distance
w: wire width

What is claimed is:

1. A composite member comprising:
a conductive layer body including an insulating layer and two conductive layers that are electrically insulated by the insulating layer and disposed to be spaced from each other;
a pressure-sensitive adhesive layer; and
a member having a higher modulus of elasticity than the pressure-sensitive adhesive layer,
wherein the member is in contact with, out of the two conductive layers, a first conductive layer provided on a side on which a radius of curvature of the insulating layer is larger in a case of bending the conductive layer body in a bending direction,
the pressure-sensitive adhesive layer is disposed at a portion except for between the insulating layer and each of the two conductive layers and at a portion except for between the first conductive layer and the member having a higher modulus of elasticity than the pressure-sensitive adhesive layer, and
the insulating layer has a higher modulus of elasticity than the pressure-sensitive adhesive layer.

2. The composite member according to claim 1,
wherein the insulating layer is flexible.

3. The composite member according to claim 1,
wherein the modulus of elasticity of the insulating layer is 10⁻¹ to 30 GPa.

4. The composite member according to claim 1,
wherein the member having a higher modulus of elasticity than the pressure-sensitive adhesive layer is formed of a sheet body and disposed on a side of the first conductive layer opposite to the insulating layer.

5. The composite member according to claim 1,
wherein a first protective layer having a higher modulus of elasticity than the pressure-sensitive adhesive layer is laminated on the first conductive layer.

6. The composite member according to claim 5,
wherein the first protective layer is in contact with the pressure-sensitive adhesive layer provided on a side of the first protective layer opposite to the conductive layer.

7. The composite member according to claim 5,
wherein, in a case where a thickness from an interface between the first protective layer and the first conductive layer to an interface of the pressure-sensitive adhesive layer that is disposed first on a side on which the radius of curvature of the insulating layer is smaller in the case of bending the conductive layer body in the bending direction is represented by td, and a thickness of the first protective layer is represented by ts, ts is equal to or smaller than td.

8. The composite member according to claim 1,
wherein a second protective layer having a thickness of 20 μm or smaller is laminated on a second conductive layer provided on a side on which a radius of curvature of the insulating layer is smaller in the case of bending the conductive layer body in the bending direction and the second protective layer is in contact with a second pressure-sensitive adhesive layer provided on a side of the second protective layer opposite to the second conductive layer.

9. The composite member according to claim 1,
wherein a second pressure-sensitive adhesive layer provided on a side on which a radius of curvature of the insulating layer is smaller in the case of bending the conductive layer body in the bending direction and a second conductive layer provided on the side on which the radius of curvature of the insulating layer is smaller in the case of bending the conductive layer body in the bending direction are in contact with each other.

10. The composite member according to claim 1,
wherein the conductive layer body has the insulating layer and the conductive layers provided on both surfaces of the insulating layer.

11. The composite member according to claim 10,
wherein the insulating layer is formed of an insulating substrate.

12. The composite member according to claim 1,
wherein the two conductive layers are formed of metal.

13. The composite member according to claim 1,
wherein a barrier layer is provided between the insulating layer and one of the two conductive layers or on the side of the two conductive layers opposite to the insulating layer, and
the barrier layer has an inorganic layer including at least silicon nitride.

14. The composite member according to claim 13,
wherein the barrier layer is a laminate structure of the inorganic layer and an organic layer.

15. The composite member according to claim 1,
wherein the pressure-sensitive adhesive layer is provided on a side of the member having a higher modulus of elasticity than the pressure-sensitive adhesive layer opposite to the first conductive layer, and
the composite member further includes a pressure-sensitive adhesive layer provided on a side of a second conductive layer opposite to the insulating layer, and the second conductive layer is provided on a side on which a radius of curvature of the insulating layer is smaller in the case of bending the conductive layer body in a bending direction.

16. A device comprising:
the composite member according to claim 1.
